(19) United States
(12) Patent Application Publication
(10) Pub. No.: US 2026/0300431 A1
(43) Pub. Date: Oct. 1, 2026

(54) NONLINEAR FUNCTION PROCESSING APPARATUS, APPROXIMATE OPERATION EXECUTION METHOD THEREOF, AND APPROXIMATE OPERATION CIRCUIT MODULE FOR PROCESSING NONLINEAR FUNCTION OPERATION

(71) Applicant: INDUSTRIAL TECHNOLOGY RESEARCH INSTITUTE, Hsinchu (TW)

(72) Inventors: Qi-Xian Wu, Chiayi City (TW); Shu-Sian Teng, New Taipei City (TW); Ming-Der Shieh, Tainan City (TW); Chih-Tsun Huang, Hsinchu City (TW); Juin-Ming Lu, Hsinchu City (TW); Yao-Hua Chen, Taoyuan City (TW)

(73) Assignee: INDUSTRIAL TECHNOLOGY RESEARCH INSTITUTE, Hsinchu (TW)

(21) Appl. No.: 19/629,375

(22) Filed: Mar. 26, 2026

Related U.S. Application Data
(60) Provisional application No. 63/779,817, filed on Mar. 28, 2025.

(30) Foreign Application Priority Data
Sep. 24, 2025 (TW) 114136852

(51) Int. Cl. G06F 17/17; G06N 3/048

(52) U.S. Cl. CPC G06F 17/17; G06N 3/048

(57) ABSTRACT

A nonlinear function processing apparatus includes: an approximate operation circuit module, disposed in a hardware structure and configured to selectively execute one of a plurality of functional operation modules according to a control signal to perform an approximate operation corresponding to a nonlinear function; an approximate control module, coupled to the approximate operation circuit module and configured to execute a data processing procedure in a logarithmic-exponential reciprocal form of the nonlinear function corresponding to the selected functional operation module, and analyze the data processing procedure to generate a corresponding control signal, to dynamically establish at least one operation path in the approximate operation circuit module; and a data guidance module, coupled to the approximate operation circuit module and configured to guide input data required by the data processing procedure to the approximate operation circuit module, and perform a corresponding operation according to the established operation path.

### CROSS-REFERENCE TO RELATED APPLICATION

This non-provisional application claims the benefit of U.S. provisional application Ser. No. 63/779,817, filed on Mar. 28, 2025, and claims the priority of patent application No. 114136852, filed in Taiwan, R.O.C. on Sep. 24, 2025. The entire of the above-mentioned patent applications is hereby incorporated by references herein and made a part of the specification.

### TECHNICAL FIELD

The present invention relates to a nonlinear function approximation method, and particularly to data processing methods corresponding to a plurality of nonlinear functions and a shared circuit structure of approximate operation circuit modules corresponding to the data processing methods

### BACKGROUND

In a modern deep learning architecture, a nonlinear function plays an extremely crucial role. Using a Transformer architecture model as an example, in addition to being used for various excitation functions, for example, a Gaussian Error Linear Unit (GELU) function, to improve model performance, a Softmax function is not only used for a classification output layer, but also deeply embedded into a self-attention mechanism. This is vastly different from a design of a traditional Convolutional Neural Network (CNN), and significantly increases a calculation proportion of the nonlinear function in a model and a resource demand, which further exacerbates an operation bottleneck in an inference process.

As deep learning models are applied to scenarios requiring low-latency responses such as machine translation, voice assistants, and real-time communication, the operation efficiency of the nonlinear functions has become a key to the overall efficiency of a system. An excessively high latency not only affects user experiences, but may even lead to system response failure. In this case, using low-complexity nonlinear approximation methods has become main means of accelerating deep learning inference.

At present, approximation methods of common nonlinear functions, for example, exp(x), log(x), Sigmoid, Tanh, GELU, Softmax, and sqrt(x), mainly include: a lookup table method, polynomial approximation, piecewise linearization, and replacing an original nonlinear function with a function having lower calculation costs. However, methods of this type are mostly designed for a single function, which lacks of reusability and generality, resulting in that different nonlinear functions need to be implemented by using independent hardware resources, and are difficultly integrated into a single hardware structure.

As operation tasks gradually shift to edge devices (for example, a smartphone, an unmanned aerial vehicle, and various types of embedded systems), implementing Artificial Intelligence (AI) inference in an environment where operation and power resources are limited has increasingly become a core direction of technical development of edge apparatuses and embedded systems. However, operations involved in the nonlinear functions usually have characteristics of high calculation complexity and high-power consumption, which has become one of main bottlenecks restricting edge devices from effectively performing an AI inference task. Therefore, there is an urgent need for a circuit design solution that can effectively integrate a plurality of nonlinear functions and balance high accuracy and low hardware complexity, to implement an AI acceleration architecture with high efficiency and high energy efficiency.

By an approximation method with a unified architecture and low resource consumption, not only hardware area and power consumption can be significantly reduced, but also AI inference accuracy can be maintained, which helps to promote widespread application of AI models in various resource-limited devices. If an operation circuit architecture which has high integrity, low costs, and extendibility to implement an operation of the nonlinear function approximation method can be designed, flexibility and application value of a hardware accelerator can be significantly enhanced, and high practicality and innovativeness in the field of deep learning hardware design can be achieved.

### SUMMARY

The present invention provides a nonlinear function approximation method. In an approximation process of a nonlinear function, impact of each step in an overall operation process on an error is considered, and the overall error is reduced through an error shifting mechanism. By combining a low-complexity approximation technology in current literature and adjusting an error shift value, the accuracy of deep learning model inference can be maintained while significantly reducing the consumption of operation resources. In recent years, to improve hardware efficiency, implementation of a nonlinear function of a deep learning model in hardware usually needs to integrate different nonlinear function hardware units to support a plurality of operations. However, in existing methods, to achieve the same error range, operation resources usually need to be additionally increased, resulting in low overall efficiency. For hardware integration of nonlinear functions, the present invention proposes two design architectures with reconfigurable units to provide a more flexible and more efficient hardware design to meet operation demands of a plurality of nonlinear functions, which can maintain high efficiency and accuracy while reducing consumption of hardware resources, and is particularly suitable for a nonlinear function approximate operation in the deep learning model. The technology of the present invention can effectively cope with the trend of increasing the scale of the deep learning model and provide more accurate and efficient solutions for nonlinear function operations.

For problems of too large model scale, too many parameters, and the like in a current Large Language Model (LLM), there is currently a lack of an effective AI model lightweight technology, and it is difficult for a system to effectively support nonlinear function operations (such as a Softmax function) required by a Transformer architecture model on a hardware implementation level. The nonlinear function operations not only require a large amount of data migration, but also have problems of time consumption and power consumption due to too long calculation time, resulting in limited overall efficiency and practicability of the system. To solve the foregoing technical bottleneck, the present invention provides a hardware structure for an AI accelerator, to significantly improve hardware execution efficiency of a nonlinear function. Specifically, according to the present invention, fixed-point characteristic analysis is performed on a nonlinear operation, for example, the Softmax function, and a scalable instruction set and a high-efficiency data path design are matched, thereby effectively reducing data migration demands and processing time in a model operation process.

The present invention provides a shared circuit structure for a nonlinear function approximation method to reduce a hardware circuit area demand while accelerating a nonlinear function operation of a deep learning model. A deep learning technology has been widely applied to the fields such as image recognition and natural language processing. The Transformer architecture model, which has attracted much attention in recent years, heavily relies on nonlinear functions (such as a Softmax function and a GELU function) in an inference process. When these nonlinear function approximation methods are implemented in hardware, to ensure relatively high accuracy, a large amount of operation resources and operation time are usually required, affecting efficiency performance of a system. To solve problems of operation latency, hardware area demand, and the like, the nonlinear function approximation method proposed in the present invention adopts a successive approximation policy, and gradually reduces an approximation error according to characteristics in different operation stages and an error shifting mechanism, thereby reducing overall operation demand. Compared with a traditional nonlinear function approximation method, higher flexibility and adaptability are exhibited without requiring (or reducing) table lookup operations. In addition, the present invention proposes a circuit design solution for a shared circuit structure based on a reconfigurable circuit module for nonlinear function approximation methods such as a Softmax function, a GELU function, a square root function, and the like, and adopts a low-complexity operation circuit component in a reconfigurable circuit module, for example, a binary logarithmic operator and a binary exponential operator designed according to approximate formulas of a binary logarithmic function and a binary exponential function, thereby reducing operation complexity.

The present invention provides a nonlinear function processing apparatus, which can be applied to a neural network system, and includes: an approximate operation circuit module, an approximate control module, and a data guidance module. The approximate operation circuit module is disposed in a hardware structure and is configured to selectively execute one of a plurality of functional operation modules according to a control signal, to perform an approximate operation of a nonlinear function corresponding to the selected functional operation module. The approximate control module is coupled to the approximate operation circuit module, and is configured to execute an operation of a data processing procedure in a logarithmic-exponential reciprocal form corresponding to the nonlinear function corresponding to the selected functional operation module, and generate a corresponding control signal according to the data processing procedure, to dynamically establish at least one corresponding operation path in the approximate operation circuit module. The data guidance module is coupled to the approximate operation circuit module, and is configured to guide input data required by the data processing procedure to the approximate operation circuit module, and perform a corresponding operation on the input data according to the established at least one operation path.

The present invention provides an approximate operation circuit module for processing a nonlinear function operation, applied to a neural network system, including: a selection circuit module, a reconfigurable circuit module, an addition circuit module, and a multiplication circuit module. The selection circuit module includes a plurality of selector units. The reconfigurable circuit module includes a plurality of reconfigurable units, and is electrically connected to the selection circuit module. The addition circuit module includes a plurality of adders, and is electrically connected to the reconfigurable circuit module. The multiplication circuit module includes a plurality of multipliers, and is electrically connected to the addition circuit module.

The present invention provides an approximate operation circuit module for processing a nonlinear function operation, applied to a neural network system, including: a comparison circuit module, a first register module, a selection circuit module, a reconfigurable circuit module, an addition circuit module, a second register module, and a multiplication circuit module. The comparison circuit module includes a plurality of comparators that are electrically connected, and is configured to perform comparison operations on input data through the plurality of comparators to obtain a maximum value of the input data. The first register module includes a plurality of register units, and is configured to store the input data and a comparison result of the comparison circuit module. The second register module includes a plurality of register units, and is configured to store operation results of the plurality of reconfigurable units of the reconfigurable circuit module, an accumulation result of the addition circuit module, and the comparison result of the comparison circuit module stored in the first register module.

The present invention provides a binary logarithmic operator. The binary logarithmic operator is configured to execute an approximate operation of a corresponding binary logarithm through a binary logarithmic approximate formula, thereby reducing operation complexity and operation costs of the binary logarithmic operator. The binary logarithmic approximate formula is: log₂ x=2^{ω}·k=ω+log₂ k≈ω+(k−1), where ω is an integer part of └log₂ x┘ and is capable of being obtained through a Most Significant Bit (MSB) of an input value x, and k is a proportional part corresponding to the input value x shifted to the right by ω digits and normalized to an interval [1,2).

The present invention provides a binary exponential operator. The binary exponential operator is configured to execute an approximate operation of a corresponding binary exponent through a binary exponential approximate formula, thereby reducing operation complexity and operation costs of the binary exponential operator. The binary exponential approximate formula is: 2^{x}=2^{x}^{ᵢₙₜ}^{+x}^{_{frac}}≈(1+x_{frac})·2^{x}^{ᵢₙₜ}, where xᵢₙᵢₜ is an integer part of the input value x, and x_{frac} is a decimal part obtained by deducting the integer part from the input value x.

The present invention provides a Softmax function approximation method. The Softmax function approximation method is to execute an operation of which represents a maximum value of the input data. a data processing procedure in a logarithmic-exponential reciprocal form of a Softmax function through an approximate operation circuit module. The logarithmic-exponential reciprocal form of the Softmax function may be expressed as:

$${S}_{j} ( x ) = \frac{{e}^{x - M} j}{{\sum }_{i = 0}^{N - 1} {e}^{x - M} i} = {2}^{{log}_{2} e ( {x}_{j} - M ) - {log}_{2} ( {\sum }_{i = 0}^{N - 1} {e}^{{x}_{i} - M} )} ,$$

where M is expressed as a maximum value of the input data, where steps corresponding to the data processing procedure in the logarithmic-exponential reciprocal form of the Softmax function include: step: M=max(x), step: x′=x−M, step: exp(x′)=2^{x′·log}^{₂}^{e}=2^{y}, step: sum, step: L2=log 2(sum), and step: exp 2(y−L2)=2^{y-L2}.

The present invention provides a GELU function approximation method. The GELU function approximation method is to execute a data processing procedure in a logarithmic-exponential reciprocal form of a GELU function through an approximate operation circuit module. The logarithmic-exponential reciprocal form of the GELU operation module may be expressed as:

$${G}_{σ} ( x ) = x \cdot σ ( 1.702 x ) = x \cdot {2}^{- l o {g}_{2} ( 1 + {e}^{- 1.702 x} )} ,$$

where σ(x) is a Sigmoid function, where steps corresponding to the data processing procedure in the logarithmic-exponential reciprocal form of the GELU function include: step: CM=−1.702·x, step: E0=2^{CM·log}^{₂}^{e}, step: ADD=1+E0, step: L2=log₂(ADD), step: E1=2^{-L2}, and step: x·E1.

The present invention provides an approximate operation method for a nonlinear function processing apparatus, including: transforming, by an approximate control module, an operation of a nonlinear function into a data processing procedure in a logarithmic-exponential reciprocal form corresponding to the nonlinear function, where the data processing procedure includes at least one logical calculation procedure, and each logical calculation procedure corresponds to a control signal; receiving, by an approximate operation circuit module, the control signal, and establishing at least one operation path in the approximate operation circuit module according to the control signal; and guiding, by a data guidance module, input data to the approximate operation circuit module, and sequentially executing various logical calculation procedures to perform approximate operations on the input data through the operation paths corresponding to the logical calculation procedures.

### BRIEF DESCRIPTION OF THE DRAWINGS

FIG. 1 is a block diagram of a system architecture of a nonlinear function processing apparatus according to an embodiment of the present invention.

FIG. 2A is a curve graph of an optimized Sigmoid function σₒₚₜ(x) according to an embodiment of the present invention.

FIG. 2B is a curve graph of a product of an optimized Sigmoid function σₒₚₜ(x) and an input value x according to an embodiment of the present invention.

FIG. 3A is a curve graph of a binary exponential approximate formula according to an embodiment of the present invention.

FIG. 3B is a curve graph of a binary logarithmic approximate formula according to an embodiment of the present invention.

FIG. 4A is a flowchart of a first logical calculation procedure of a data processing procedure of a Softmax function according to an embodiment of the present invention.

FIG. 4B is a schematic diagram of an operation path established by an approximate operation circuit module corresponding to a first logical calculation procedure of a Softmax function according to an embodiment of the present invention.

FIG. 5A is a flowchart of a second logical calculation procedure of a data processing procedure of a Softmax function according to an embodiment of the present invention.

FIG. 5B is a schematic diagram of an operation path established by an approximate operation circuit module corresponding to a second logical calculation procedure of a Softmax function according to an embodiment of the present invention.

FIG. 6A is a flowchart of a first logical calculation procedure of a data processing procedure of a GELU function according to an embodiment of the present invention.

FIG. 6B is a schematic diagram of an operation path established by an approximate operation circuit module corresponding to a first logical calculation procedure of a GELU function according to an embodiment of the present invention.

FIG. 7A is a flowchart of a second logical calculation procedure of a data processing procedure of a GELU function according to an embodiment of the present invention.

FIG. 7B is a schematic diagram of an operation path established by an approximate operation circuit module corresponding to a second logical calculation procedure of a GELU function according to an embodiment of the present invention.

FIG. 8 is a circuit diagram of a selector unit of an approximate operation circuit module according to an embodiment of the present invention.

FIG. 9 is a circuit diagram of a reconfigurable unit of an approximate operation circuit module according to an embodiment of the present invention.

FIG. 10 is a circuit diagram of a register unit of an approximate operation circuit module according to an embodiment of the present invention.

FIG. 11 is a circuit diagram of an approximate operation circuit module according to an embodiment of the present invention.

FIG. 12 is a circuit diagram of a reconfigurable unit of an approximate operation circuit module according to an embodiment of the present invention.

FIG. 13A is a schematic diagram of a first operation architecture of an approximate operation circuit module corresponding to a data processing procedure of a Softmax function according to an embodiment of the present invention.

FIG. 13B is a schematic diagram of a data processing path established by a first operation architecture of an approximate operation circuit module corresponding to a data processing procedure of a Softmax function according to an embodiment of the present invention.

FIG. 14A is a schematic diagram of a second operation architecture of an approximate operation circuit module corresponding to a data processing procedure of a Softmax function according to an embodiment of the present invention.

FIG. 14B is a schematic diagram of a data processing path established by a second operation architecture of an approximate operation circuit module corresponding to a data processing procedure of a Softmax function according to an embodiment of the present invention.

FIG. 15 is a flowchart of a data processing procedure of a Softmax function approximation method according to an embodiment of the present invention.

FIG. 16 is a flowchart of a data processing procedure of a GELU function approximation method according to an embodiment of the present invention.

FIG. 17 is an approximate operation execution method for a nonlinear function processing apparatus according to an embodiment of the present invention.

### DETAILED DESCRIPTION

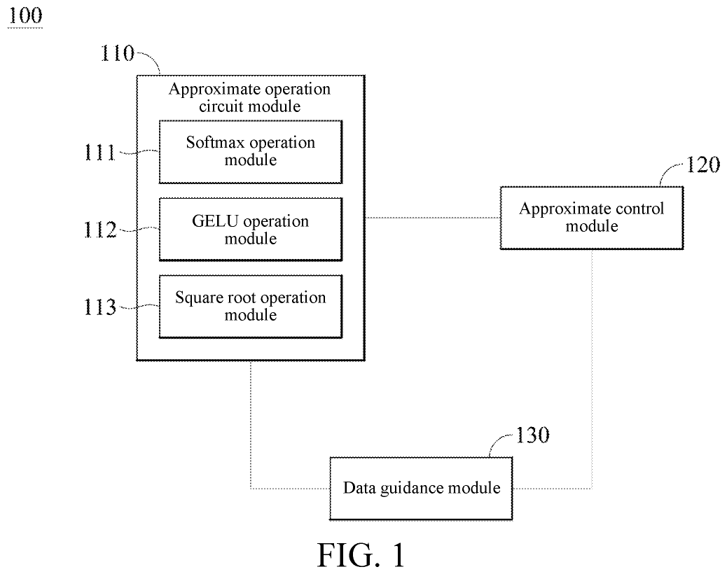

FIG. 1 is a block diagram of a system architecture of a nonlinear function processing apparatus according to an embodiment of the present invention. In the embodiment shown in FIG. 1, a nonlinear function processing apparatus 100 may be applied to a neural network system, and includes: an approximate operation circuit module 110, an approximate control module 120, and a data guidance module 130. The approximate operation circuit module 110 is disposed in a hardware structure, for example, a Field-Programmable Gate Array (FPGA) or an Application-Specific Integrated Circuit (ASIC). The approximate operation circuit module 110 selectively executes one of a plurality of functional operation modules through a shared circuit structure thereof. The plurality of functional operation modules includes: a Softmax operation module 111, a GELU operation module 112, and a square root operation module 113. Each functional operation module is configured to execute an operation required by a corresponding nonlinear function approximation method through the shared circuit structure of the approximate operation circuit module 110. To support an operation demand of various functional operation modules, at least one corresponding operation path may be dynamically established in the shared circuit structure of the approximate operation circuit module 110 according to a group of control signals, to respectively implement operations required by the Softmax operation module 111, the GELU operation module 112, and the square root operation module 113.

The approximate control module 120 is coupled to the approximate operation circuit module 110. The approximate control module 120 is configured to execute an operation of a data processing procedure in a logarithmic-exponential reciprocal form of the nonlinear function corresponding to each functional operation module in the plurality of functional operation modules. A corresponding control signal is generated according to the data processing procedure corresponding to each functional operation module and is transmitted to the approximate operation circuit module 110, to dynamically establish at least one corresponding operation path in the approximate operation circuit module 110. The data processing procedure corresponding to the nonlinear function approximation method includes a plurality of calculation steps, which are a plurality of calculation formulas designed based on the data processing procedure in the logarithmic-exponential reciprocal form of the nonlinear function. The approximate control module 120 may transform an operation of the nonlinear function into an operation of the data processing procedure in the logarithmic-exponential reciprocal form. The data processing procedure may include one or a plurality of logical calculation procedures. Each logical calculation procedure corresponds to one or a plurality of calculation formulas (or calculation steps) in the data processing procedure. The approximate control module 120 is configured to control a circuit component in the approximate operation circuit module 110 according to the corresponding control signal generated by each logical calculation procedure, to dynamically establish at least one corresponding operation path in the approximate operation circuit module 110. In other words, the data processing procedure corresponding to the nonlinear function approximation method includes at least one logical calculation procedure and a control signal corresponding to each logical calculation procedure.

The data guidance module 130 is coupled to the approximate operation circuit module 110. The data guidance module 130 is configured to guide input data required by the data processing procedure to the approximate operation circuit module 110, and perform a corresponding operation on the input data according to the established at least one operation path. In an embodiment, the input data of the nonlinear function is usually vector data. A group of vector data includes a plurality of data elements. The data guidance module 130 divides the plurality of data elements in the input data into a plurality of data elements, and guides these data subsets to the approximate operation circuit module 110 in batches, to process these data subsets in batches through the operation path corresponding to the approximate operation circuit module 110. In addition, when the data processing procedure includes a plurality of logical calculation procedures sequentially executed, the data guidance module 130 may repeatedly guide an operation result (or intermediate data) of the approximate operation circuit module 110 corresponding to one of the logical calculation procedures to the approximate operation circuit module 110 through at least one data reuse path, for a subsequently executed another logical calculation procedure to use.

In an embodiment, the approximate operation circuit module 110 may be implemented in an FPGA or an ASIC, and includes a reconfigurable circuit module 420. In an implementation of the FPGA, circuit components, for example, a subtractor, an adder, a multiplier, a selector, and an operational logical gate, included in the reconfigurable circuit module 420 may be defined through a Hardware Description Language (HDL), for example, Verilog or Very-High-Speed Integrated Circuit Hardware Description Language (VHDL). A control signal is used for controlling logical combinations and data transmission paths of the circuit components. For example, in the reconfigurable circuit module 420, a data path configuration is dynamically adjusted by using a selector to implement logical calculation procedures required by various functional operation modules. Therefore, the approximate operation circuit module 110 has reconfigurability and multifunctionality. In an implementation of the ASIC, a corresponding functional operation module is selectively enabled through a plurality of selection paths or configuration control modules (for example, a microinstruction decoder), to support approximate operations of different nonlinear functions.

In an embodiment, the approximate operation circuit module 110 has a plurality of functional operation modules, including: a Softmax operation module 111, a GELU operation module 112, and a square root operation module 113. Specifically, the Softmax operation module 111 is configured to execute an approximate operation of a data processing procedure in a logarithmic-exponential reciprocal form of a Softmax function; the GELU operation module 112 is configured to execute an approximate operation of a data processing procedure in a logarithmic-exponential reciprocal form of a GELU function; and the square root operation module 113 is configured to execute an approximate operation of a data processing procedure in a logarithmic-exponential reciprocal form of a square root function. In other words, the approximate operation circuit module 110 controls circuit components in a shared circuit structure of the approximate operation circuit module 110 according to a control signal, to dynamically establish at least one corresponding operation path in the shared circuit structure, to implement operations required by various functional operation modules when processing input data,

In an embodiment, a group of control signals include a plurality of individual control signals for respectively controlling various circuit components in the approximate operation circuit module 110. Different settings of the control signals can be formed by using control signal configurations of different combinations, and various settings respectively correspond to different operation paths, to implement required logical functions and data transmission processes. It is particularly to be noted that the approximate operation circuit module 110 in this embodiment is not an exclusive and fixed circuit structure individually designed for nonlinear functions such as a Softmax function, a GELU function, and a square root function, but is a circuit architecture designed by using the reconfigurable circuit module 420, and can dynamically establish a corresponding operation path in the shared circuit structure of the approximate operation circuit module 110 according to a corresponding control signal to correspond to each functional operation module. In other words, corresponding logical components and arithmetic components may be connected to the shared circuit structure in series according to calculation steps of the data processing procedures corresponding to various nonlinear functions, to implement required operations.

In an embodiment, the shared circuit structure of the approximate operation circuit module 110 has high modularity and elasticity, which can effectively save hardware resources and support approximate operations of a plurality of function types. In addition, the logical components and the arithmetic components used in the shared circuit structure belong to circuit component with low logical complexity. The data processing procedures designed for logarithmic-exponential reciprocal forms of various nonlinear functions such as the Softmax function, the GELU function, or the square root function usually include a plurality of calculation formulas (or calculation steps). All of these calculation formulas (or calculation steps) may be implemented through the low-complexity circuit components in the shared circuit structure.

In an embodiment, the Softmax operation module 111 of the approximate operation circuit module 110 is configured to execute the approximate operation of the data processing procedure in the logarithmic-exponential reciprocal form corresponding to the Softmax function. An original formula of the Softmax function may be transformed into the logarithmic-exponential reciprocal form by performing a logarithmic-exponential reciprocal operation. Specifically, a logarithm with a base of 2 is taken for the original formula of the Softmax function to perform first transformation, and then an exponent with a base of 2 is taken to perform second transformation, thereby obtaining the logarithmic-exponential reciprocal form of the Softmax function. The logarithmic-exponential reciprocal form of the Softmax function is equivalent to an identical relationship of the original formula of the Softmax function. The data processing procedure designed through the logarithmic-exponential reciprocal form of the Softmax function usually includes a low-complexity calculation formula (or a calculation step), to implement a Softmax function approximation method through the low-complexity circuit component configured in the approximate operation circuit module 110 (for example, a binary logarithmic operator and a binary exponential operator proposed in the present invention), thereby improving hardware efficiency. In this way, operation resource consumption and latency can be effectively reduced, thereby achieving hardware acceleration.

In an embodiment, the original formula of the Softmax function includes an operation item with dense operation resources, for example, an exponential operation and a division operation. The formula corresponding to the Softmax function (corresponding to a j^{th} output component) may be expressed as:

$${S}_{j} ( x ) = \frac{{e}^{{x}_{j}}}{{\sum }_{i = 0}^{N - 1} {e}^{{x}_{i}}}$$

If the Softmax function is implemented in a traditional way, a large amount of calculation resources and memory resources will be consumed, leading to hardware latency and increased power consumption.

The input data to be processed by the Softmax function is usually vector data, and the input data may be expressed as: x={x₀, x₁, . . . , x_{N-1}}. To improve numerical stability and avoid arithmetic overflow generated in an exponential operation, maximum value shift processing may be performed on the input data first to transform the Softmax function into a ┌Safe Softmax function┘ form, and the corresponding formula may be expressed as:

$${S}_{j} ( x ) = \frac{{e}^{{x}_{j} - M}}{{\sum }_{i = 0}^{N - 1} {e}^{{x}_{i} - M}}$$

where M=max(x), which represents a maximum value of the input data. The foregoing transformation essentially does not affect an output proportional relationship of the Softmax function, but can reduce numerical accuracy loss caused by a too large or too small exponential term.

To further reduce complexity of an implementation of hardware, this embodiment provides a Softmax function approximation method to transform a Softmax function into a logarithmic-exponential reciprocal form, analyze a data processing procedure required by the Softmax function approximation method to infer a plurality of calculation formulas (or calculation steps) required by the Softmax function approximation method from the data processing procedure, design a circuit structure of these calculation formulas (or calculation steps) through low-complexity operation circuit components. In other words, an original operation that needs to be implemented through an exponential operation and division is correspondingly transformed into an operation form that can be completed by addition, subtraction, multiplication, a binary exponential function, and a binary logarithmic function through a logarithmic-exponential reciprocal transformation technology with a base of 2, thereby effectively simplifying an overall circuit design. Specifically, a logarithm with a base of 2 is taken for the Softmax function, and a corresponding formula may be expressed as:

$${log}_{2} ( {S}_{j} ( x ) ) = {log}_{2} e ( {x}_{j} - M ) - {log}_{2} ( {\sum }_{i = 0}^{N - 1} {e}^{{x}_{i} - M} )$$

An exponent with a base of 2 may be taken to obtain a logarithmic-exponential reciprocal form of the Softmax function, and a corresponding formula may be expressed as:

$${S}_{j} ( x ) = {2}^{{log}_{2} e ( {x}_{j} - M ) - {log}_{2} ( {\sum }_{i = 0}^{N - 1} {e}^{{x}_{i} - M} )}$$

By using a reciprocal relationship between a logarithm and an exponent, the Softmax operation module 111 of the approximate operation circuit module 110 implements the approximate operation of the Softmax function through a low-complexity operation circuit component. Compared with a traditional way, the Softmax function approximation method proposed in this embodiment has significant advantages in aspects of power consumption, latency, and logical gate area, and is particularly suitable for an AI accelerator or a resource-limited edge apparatus.

In an embodiment, the GELU function operation module of the approximate operation circuit module 110 is configured to execute the approximate operation of the data processing procedure in the logarithmic-exponential reciprocal form corresponding to the GELU function. A nonlinear characteristic of the GELU function is similar to that of a Rectified Linear Unit (ReLU) function, so an approximation method of the GELU function may use a similar method. Specifically, the ReLU function approximation method is to perform nonlinear approximation on a heaviside step function in advance, and then multiply an approximate result by an input value; and the GELU function approximation method is to perform nonlinear approximation on a cumulative distribution function Φ(x) in a standard normal distribution, and then multiply an approximate result by an input value. Therefore, a formula corresponding to the GELU function approximation method may be expressed as: GELU(x)=x·Φ(x). In addition, in a hardware design or high-performance implementation, the GELU function approximation method usually uses a Sigmoid function to perform approximation to reduce operation complexity of an operator, and a formula corresponding to the GELU function approximation method may be expressed as:

$$GELU ( x ) \approx x \cdot σ ( 1.702 x )$$

where σ(x) is a Sigmoid function, and may be expressed as:

$$σ ( x ) = \frac{1}{1 + {e}^{- x}} .$$

The GELU function approximation method is to multiply an optimization constant 1.702 serving as a scaling factor by an input value x, so that σ(1.702x) can effectively approximate a curve shape of the standard normal distribution function Φ(x) in an input interval. By using such transformation, integral operations involved in an original GELU function may be replaced by using multiplication and a Sigmoid function operation, which can implement a smoother nonlinear response characteristic, and can significantly simplify design and implementation complexity of a hardware circuit.

To further reduce complexity of an implementation of hardware, this embodiment provides a GELU function approximation method to transform a logarithmic-exponential reciprocal form of the Sigmoid function in the GELU function, analyze a data processing procedure required by the GELU function approximation method to infer a plurality of calculation formulas (or calculation steps) required by the Sigmoid function approximation method from the data processing procedure, and design a circuit structure of these calculation formulas (or calculation steps) through low-complexity operation circuit components. In other words, an original operation that needs to be implemented through an exponential operation and division is correspondingly transformed into an operation form that can be completed by addition, subtraction, multiplication, a binary exponential function, and a binary logarithmic function through a logarithmic-exponential reciprocal transformation technology with a base of 2, thereby effectively simplifying an overall circuit design. Specifically, a logarithm with a base of 2 is taken for the Sigmoid function, and a formula corresponding to the Sigmoid function may be expressed as:

$${log}_{2} ( σ ( x ) ) = - {log}_{2} ( 1 + {e}^{- x} )$$

An exponent with a base of 2 is taken to obtain a logarithmic-exponential reciprocal form of the Sigmoid function, and a corresponding formula may be expressed as:

$$σ ( x ) = {2}^{- {log}_{2} ( 1 + {e}^{- x} )}$$

Further, the logarithmic-exponential reciprocal form of the Sigmoid function is applied to the GELU function approximation method, and a corresponding formula may be expressed as:

$${G}_{σ} ( x ) = x \cdot {2}^{- {log}_{2} ( 1 + {e}^{- 1.702 x} )}$$

By using a reciprocal relationship between a logarithm and an exponent, the GELU operation module 112 of the approximate operation circuit module 110 implements the approximate operation of the GELU function through a low-complexity operation circuit component. Compared with a traditional design manner, the GELU function approximation method proposed in this embodiment has significant advantages in aspects of power consumption, latency, and logical gate area, and is particularly suitable for an AI accelerator or a resource-limited edge apparatus.

A main error of the GELU function approximation method is from a difference between the Sigmoid function σ(1.702x) and the cumulative distribution function Φ(x) in the standard normal distribution. To further reduce this error, in an embodiment, the Sigmoid function is optimized by introducing a scaling parameter α and a shift parameter β, and a corresponding formula may be expressed as:

$${σ}_{opt} ( x ) = σ ( α ( x + β ) )$$

By introducing the scaling parameter α and the shift parameter β, the optimized Sigmoid function σₒₚₜ(x) may more accurately approximate the cumulative distribution function Φ(x) in the standard normal distribution in an input interval x∈[−1,1].

Further, the optimized Sigmoid function σₒₚₜ(x) is multiplied by the input value x, and a symmetry formula corresponding to the GELU function approximation method can be obtained in a manner of processing positive and negative regions in stages, which may be expressed as:

$${GELU}_{σ} ( x ) = x \cdot {σ}_{opt} ( x ) = \{ \begin{matrix}x \cdot σ ( α ( x + β ) ) , & x < 0 \\ x \cdot σ ( α ( x - β ) ) , & x \geq 0\end{matrix}$$

The symmetry formula GELU. (x) corresponding to the GELU function approximation method may perform staged processing on the input value x, α(x−β) is used in a positive region, and α(x+β) is used in a negative region, so that symmetry of an output curve in the positive region and the negative region is improved, and the output curve is closer to a curve shape of the cumulative distribution function Φ(x) in the standard normal distribution, thereby reducing an approximation error. In addition, if an approximate operation is performed by using a Lookup Table (LUT), table lookup content on only one side may be implemented by using a symmetry characteristic of a target function, and a corresponding output on the other side is generated in a mirror mapping manner, thereby effectively saving spatial configuration of lookup table memory, and improving overall hardware running efficiency. In an embodiment, a Quasi-Newton method is used as an optimization tool. The Quasi-Newton method aims to minimize a Mean Absolute Error (MAE) of the Sigmoid function σₒₚₜ(x) and the cumulative distribution function Φ(x) in the standard normal distribution in an input interval x∈[−1,1], to infer optimization parameters α and β. For example, α=1.95, β=0.12. In this embodiment, the optimized GELU function GELU. (x) can effectively reduce errors, thereby improving hardware implementation accuracy of the overall GELU function.

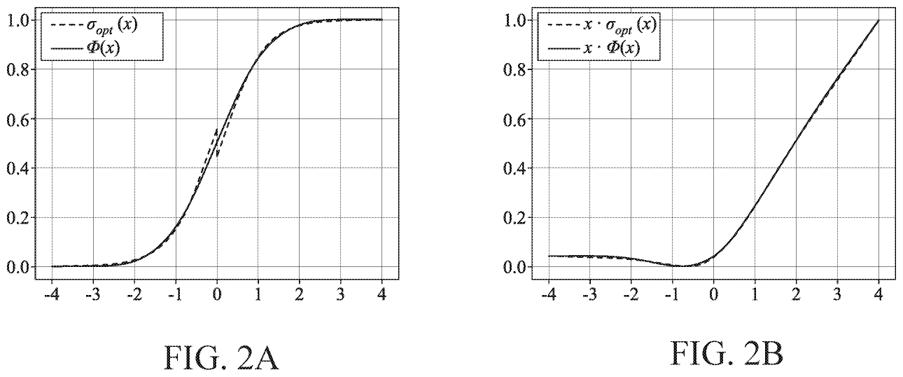

Refer to FIG. 2A and FIG. 2B below simultaneously. FIG. 2A is a curve graph of an optimized Sigmoid function σₒₚₜ(x) according to an embodiment of the present invention; and FIG. 2B is a curve graph of a product of an optimized Sigmoid function σₒₚₜ(x) and an input value x according to an embodiment of the present invention. As shown in FIG. 2A, a solid line shows an output curve of the cumulative distribution function Φ(x) in the standard normal distribution in an input interval x∈[−4, 4]. A dashed line shows an output curve of an optimized Sigmoid function σₒₚₜ(x)=σ(α(x+8) within the input interval x∈[−4,4], where α is a scaling parameter and β is a shift parameter, which can be obtained through the Quasi-Newton method, and are used for adjusting a curve shape of the Sigmoid function, so that the curve shape of the Sigmoid function is closer to the cumulative distribution function Φ(x) in the standard normal distribution. In an embodiment, within the input interval x∈[−4,4], the MAE of the optimized Sigmoid function σₒₚₜ(x) and the cumulative distribution function Φ(x) in the standard normal distribution is 0.0071.

As shown in FIG. 2B, a solid line shows an output curve of a product of the cumulative distribution function Φ(x) in the standard normal distribution and the input value x within an input interval x∈[−4,4], and is used for representing an actual curve of the GELU function, which may be denoted as x·Φ(x). A dashed line shows an output curve of a product of the optimized Sigmoid function and the input value x within an input interval x∈[−4,4], and is used for representing a curve of an optimized GELU function based on the optimized Sigmoid function, which may be denoted as x·σₒₚₜ(x). In an embodiment, within the same input interval x∈[−4,4], the MAE of the optimized GELU function x·σₒₚₜ(x) and an actual GELU function x·Φ(x) is 0.0054. Therefore, the MAE in FIG. 2B is significantly lower than that in FIG. 2A (that is, the GELU function is not multiplied by the input value x). This result shows that the optimized GELU function x. σₒₚₜ(x), (that is, the optimized Sigmoid function is multiplied by the input value x) can effectively reduce errors, thereby improving hardware implementation accuracy of the overall GELU function.

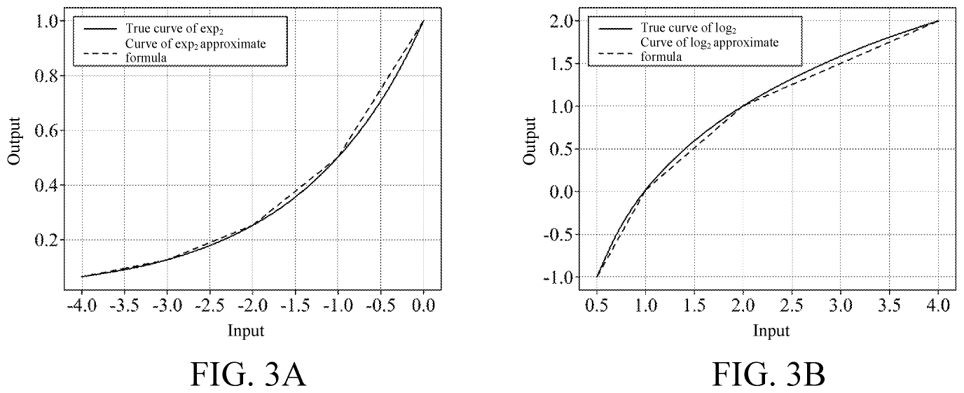

FIG. 3A is a curve graph of a binary exponential approximate formula according to an embodiment of the present invention. To effectively implement the operation of the binary exponential function in a hardware circuit, the present invention provides a binary exponential approximate formula. Firstly, the input value x is rounded down to obtain an integer part xᵢₙₜ=└x┘. Secondly, the integer part is subtracted from the input value x to obtain a decimal part x_{frac}=x−xᵢₙₜ. Finally, the integer part and the decimal part are respectively processed according to a characteristic of an exponential function, 2^{x}=2^{x}^{ᵢₙₜ}^{+x}^{_{frac}}=2^{x}^{ᵢₙₜ}·2^{x}^{_{frac}}, to obtain an approximate value of 2^{x}. Specifically, 2^{x}^{ᵢₙₜ} can be rapidly calculated by the integer part xᵢₙₜ through a shift operation without using a multiplier. As for the decimal part, 2^{x}^{_{frac}} may be approximately calculated only through an addition operation by directly using 1+x_{frac} as an estimated value without looking up a table or applying linear or polynomial approximation technologies. In conclusion, the binary exponential approximate formula may be expressed as:

$${2}^{x} = {2}^{{x}_{i n t} + {x}_{frac}} \approx ( 1 + {x}_{frac} ) ⋅ {2}^{{x}_{i n t}}$$

The approximate operation of the binary exponential approximate formula can be completed only through subtraction, addition, multiplication, and a shift operation without using floating-point multiplication, looking up a table, or applying other high-complexity approximate technologies, and is particularly suitable to be applied to a resource-limited low-power consumption and low-latency hardware circuit design. In an embodiment, a corresponding binary exponential operator may be designed based on the binary exponential approximate formula to implement a circuit structure required by the approximate operation, which is particularly suitable for an ASIC and an FPGA. As shown in FIG. 3A, a solid line shows a true curve of the binary exponential function. A dashed line shows a curve of the binary exponential approximate formula, that is, an approximate curve corresponding to (1+x_{frac})·2^{x}^{ᵢₙₜ}. An error between the true curve and the approximate curve is within an acceptable range, which is sufficient to meet an operation demand of a common nonlinear activation function in a neural network, for example, approximate operations for a Softmax function, a Sigmoid function, a GELU function, or a square root function.

FIG. 3B is a curve graph of a binary logarithmic approximate formula according to an embodiment of the present invention. To effectively perform an operation of a binary logarithmic function in a hardware circuit, the present invention provides a binary logarithmic approximate formula. Firstly, a logarithm with a base of 2 is taken for an input value x, and
the input value x is rounded down to obtain an integer part ω=└log₂ x┘. In an embodiment, the integer part may be obtained by determining an MSB of the input value through a logical circuit. Secondly, the input value x is shifted to the right by ω digits, and is normalized to an interval (1, 2) to retain the proportional part: k=x>>ω, where k is used for approximating a decimal part of log₂ x. In an embodiment, the proportional part k may be implemented through a right shift operation, which is equivalent to dividing the input value x by 2^{ω}, that is, k=x÷2^{ω}. The input value x may be expressed as x=2^{ω}·k. A logarithm with a base of 2 is taken, and a corresponding formula may be expressed as:

$${log}_{2} x = {log}_{2} ( {2}^{ω} \cdot k ) = ω + {log}_{2} k$$

The decimal part of log₂ x may be estimated through an approximate value of log₂ k. Because k∈[1,2), when the approximate value of log₂ k is calculated, k−1 may be directly used as the approximate value of log₂ k, that is, log₂ k≈(k−1). In conclusion, the binary exponential approximate formula may be expressed as:

$${log}_{2} x \approx ω + ( k - 1 )$$

The approximate operation of the binary logarithmic approximate formula can be completed only through subtraction, addition, and a shift operation without using floating-point division, looking up a table, or applying linear or polynomial approximate technologies, and is particularly suitable to be applied to a resource-limited low-power consumption and low-latency hardware circuit design. In an embodiment, in a hardware circuit design, a corresponding binary logarithmic operator may be designed based on the binary logarithmic approximate formula to implement a circuit structure required by the approximate operation, which is particularly suitable for an ASIC and an FPGA. As shown in FIG. 3B, a solid line shows a true curve of the binary logarithmic function. A dashed line shows a curve of the binary logarithmic approximate formula, that is, an approximate curve corresponding to ω+ (k−1). An error between the true curve and the approximate curve is within an acceptable range, which is sufficient to meet an operation demand of a common nonlinear activation function in a neural network, for example, approximate operations for a Softmax function, a Sigmoid function, a GELU function, or a square root function.

In an embodiment, a square root operation may be transformed into a combination operation of the logarithmic operation and the exponential operation by using a duality relationship between the logarithmic operation and the exponential operation, and a corresponding formula may be expressed as:

$$SQRT ( x ) = {x}^{0.5} = {2}^{{log}_{2} ( {x}^{0.5} )} = {2}^{0.5 \times {log}_{2} ( x )}$$

Implementing the square root function through a combination operation method has the advantages that the approximate operation of a square root can be completed by only using low-complexity operations, such as a binary logarithmic function, a binary exponential function, and multiplication. In an embodiment, the approximate operation of the square root function may be implemented through a combination operation architecture of a binary logarithmic operator and a binary exponential operator designed in the present invention based on a binary logarithmic approximate formula and a binary exponential approximate formula without additionally designing an exclusive square root operation circuit. This combination operation architecture can not only significantly reduce operation complexity of the square root function, but also improve overall operation efficiency and reusability of hardware modules.

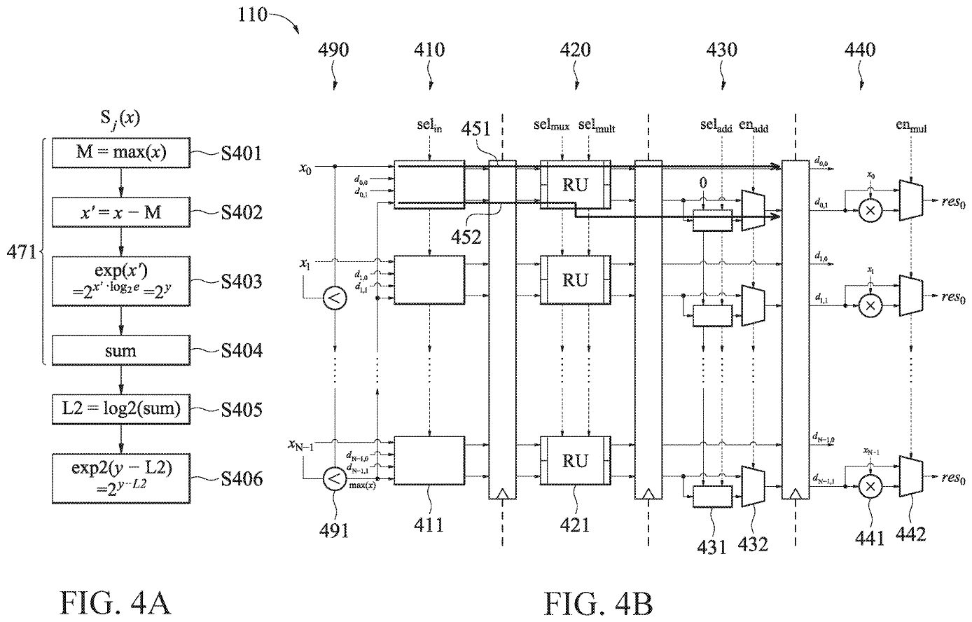

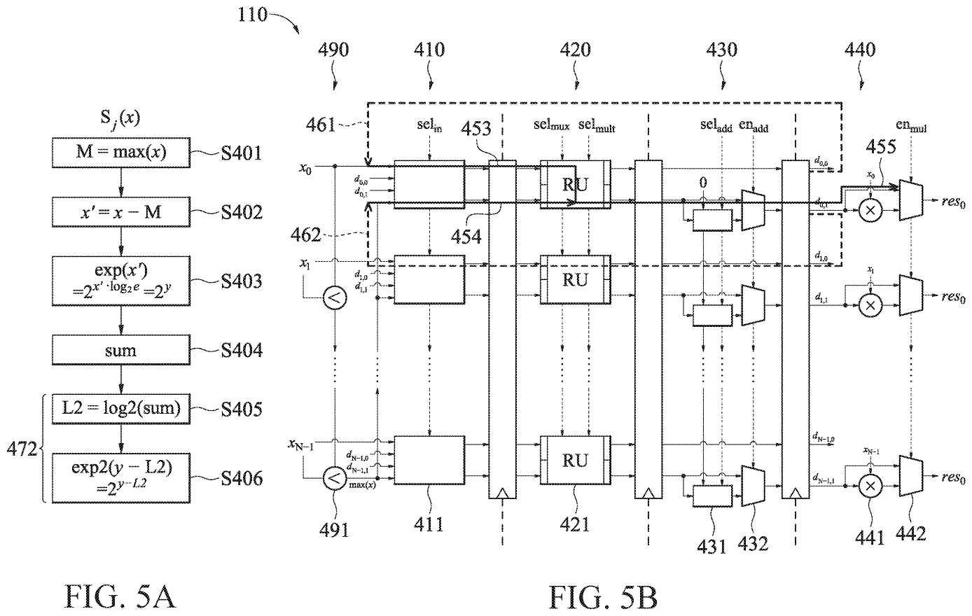

Refer to FIG. 4A to FIG. 5B below simultaneously. FIG. 4A is a flowchart of a first logical calculation procedure of a data processing procedure of a Softmax function according to an embodiment of the present invention; FIG. 4B is a schematic diagram of an operation path established by an approximate operation circuit module corresponding to a first logical calculation procedure of a Softmax function according to an embodiment of the present invention; FIG. 5A is a flowchart of a second logical calculation procedure of a data processing procedure of a Softmax function according to an embodiment of the present invention; and FIG. 5B is a schematic diagram of an operation path established by an approximate operation circuit module corresponding to a second logical calculation procedure of a Softmax function according to an embodiment of the present invention. In an embodiment, the present disclosure provides a nonlinear function processing apparatus 100, which may be applied to a neural network system, and implement an approximation method of a Softmax function through an approximate operation circuit module 110, an approximate control module 120, and a data guidance module 130. A Softmax function approximation method aims to reduce complexity of the Softmax function when implemented in hardware. For example, a formula corresponding to the Softmax function is transformed in a logarithmic-exponential reciprocal form, to implement a required operation through a low-complexity operation circuit component. A formula corresponding to the logarithmic-exponential reciprocal form of the Softmax function (a j^{th} output component) may be expressed as:

$${S}_{j} ( x ) = \frac{{e}^{{x}_{j} - M}}{{\sum }_{i = 0}^{N - 1} {e}^{{x}_{i} - M}} = {2}^{l o {g}_{2} e ( {x}_{j} - M ) - l o {g}_{2} ( {\sum }_{i = 0}^{N - 1} {e}^{{x}_{i} - M} )}$$

where M=max(x), which represents a maximum value of the input data. A plurality of calculation formulas (or calculation steps) corresponding to the data processing procedure of the Softmax function may be inferred according to the logarithmic-exponential reciprocal form of the Softmax function, and these calculation formulas (or calculation steps) may implement required calculations only by operation forms such as addition, subtraction, multiplication, a binary exponential function, and a binary logarithmic function. In this way, the shared circuit structure of the approximate operation circuit module 110 is designed by only using a low-complexity circuit component. The binary logarithmic operator and the binary exponential operator that are designed according to the binary logarithmic approximate formula and the binary exponential approximate formula and are proposed in the present invention may be integrated into the approximate operation circuit module 110, thereby improving operation efficiency and reducing power consumption.

As shown in FIG. 4A and FIG. 5A, the data processing procedure in the logarithmic-exponential reciprocal form of the Softmax function may be used for inferring a plurality of calculation formulas (or calculation steps), that is, step S401 to step S406. The data processing procedure corresponding to the Softmax function includes a first logical calculation procedure 471 and a second logical calculation procedure 472. The first logical calculation procedure 471 corresponds to step S401 to step S404. By analyzing step S401 to step S404, a group of control signals corresponding to the first logical calculation procedure 471 may be obtained for controlling a circuit component in the approximate operation circuit module 110 to dynamically establish at least one operation path, thereby executing operations corresponding to step S401 to step S404. Similarly, the second logical calculation procedure 472 corresponds to step S405 and step S406. By analyzing step S405 and step S406, a group of control signals corresponding to the second logical calculation procedure 472 may be obtained for controlling a circuit component in the approximate operation circuit module 110 to dynamically establish at least one operation path, thereby executing operations corresponding to step S405 and step S406.

The Softmax function approximation method is to perform an operation on the input data and generate a corresponding operation result according to the data processing procedure designed in the logarithmic-exponential reciprocal form, including a plurality of calculation formulas (or calculation steps) executed sequentially. In other words, the data processing procedure corresponding to the Softmax function approximation method includes a plurality of steps (steps S601 to S606). Various steps are described as follows:
Step S401: M=max(x). A maximum value is obtained from input data x={x₀, x₁, . . . , x_{N-1}} to obtain a reference value M. In an implementation, the reference value M may be obtained by a comparison result of a comparison circuit module.
Step S402: x′=x−M. Shift processing is performed on the value. The maximum value of the input data is shifted to zero through an offset operation, and the remaining data elements are relatively reduced, to ensure that the input value of the exponential operation is a non-positive number, thereby preventing numerical overflow or exponential explosion.
Step S403: exp(x′)=2^{x′·log}^{₂}^{e}=2^{y} A natural exponential function is transformed into an exponential form with a base of 2, thereby facilitating implementing a low-complexity circuit component. In an implementation, y=x′·log₂ e is calculated through a multiplier first, and then a corresponding exponential value 2^{y} is obtained by using a binary exponential operator.
Step S404: sum. The sum corresponds to a summation operation of denoms in an original Softmax function formula. Various exponential values 2^{y}^{ᵢ} obtained in step S403 are summed to obtain a sum value

$$sum = {\sum }_{i = 0}^{N - 1} {2}^{{y}_{i}} .$$

Step S405: L2=log 2(sum). A logarithm with a base of 2 is taken for the sum value, to transform division required by the original Softmax function into subtraction and an exponential operation, thereby facilitating a subsequent operation. In an implementation, a logarithmic value L2 corresponding to the sum value may be obtained through the binary logarithmic operator.
Step S406: exp 2(y−L2)=2^{y-L2}. An exponent with a base of 2 is taken for y−L2, to obtain an output component Sⱼ(x) of the Softmax function. In an implementation, y−L2 is calculated first, and then an exponential value 2^{y-L2} corresponding to y−L2 is obtained through the binary exponential operator.

In the data processing procedure corresponding to the Softmax function, for the operations of a binary logarithm and a binary exponent, the binary logarithmic operator and the binary exponential operator may be designed by using the binary logarithmic approximate formula log₂ x≈ω+(k−1) and the binary exponential approximate formula 2^{x}≈(1+x_{frac})·2^{x}^{ᵢₙₜ} proposed in the present invention, thereby reducing operation complexity.

In an embodiment, the approximate operation circuit module 110 of the nonlinear function processing apparatus 100 includes a shared circuit structure formed by a selection circuit module 410, a reconfigurable circuit module 420, an addition circuit module 430, and a multiplication circuit module 440, and is configured to enable a Softmax operation module 111 to execute an operation corresponding to the Softmax function. The data processing procedure corresponding to the Softmax operation module 111 includes a plurality of logical calculation procedures. Each logical calculation procedure corresponds a group of control signals, to dynamically establish at least one operation path in the approximate operation circuit module 110 according to this group of control signals. These operation paths corresponding to the logical calculation procedures may operate independently or in parallel in the approximate operation circuit module 110, to execute operations required by the calculation formulas (or the calculation steps) corresponding to various logical calculation procedures.

In an embodiment, by analyzing step S401 to step S404 (that is, a first logical calculation procedure 471) and step S405 and step S406 (that is, a second logical calculation procedure 472) of the data processing procedure of the Softmax function approximation method, a group of corresponding control signals can be separately obtained for controlling the approximate operation circuit module 110 to execute corresponding operations. According to the control signals corresponding to the first logical calculation procedure 471, the approximate operation circuit module 110 may dynamically establish a first operation path 451 and a second operation path 452 in the shared circuit structure of the approximate operation circuit module 110, and execute corresponding operations through circuit components on these operation paths, to obtain calculation results of step S401 to step S404. In short words, the first logical calculation procedure 471 shown in FIG. 4A corresponds to operation paths (451 and 452) shown in FIG. 4B. Similarly, according to the control signals corresponding to the second logical calculation procedure 472, the approximate operation circuit module 110 may dynamically establish a third operation path 453, a fourth operation path 454, and a fifth operation path 455 in the shared circuit structure of the approximate operation circuit module 110, and execute corresponding operations through circuit components on these operation paths, to obtain calculation results of step S405 and step S406. In short words, the second logical calculation procedure 472 shown in FIG. 5A corresponds to operation paths (453 to 455) shown in FIG. 5B.

As shown in FIG. 5B, to meet a demand of reusing intermediate data in the Softmax function approximation method, a calculation result (intermediate data) of the first logical calculation procedure 471 may be provided for the second logical calculation procedure 472 for subsequent use through at least one data reuse path in the approximate operation circuit module 110. The approximate operation circuit module 110 provides a first data reuse path 461 and a second data reuse path 462. The first logical calculation procedure 471 obtains the operation result (the intermediate data) of the first logical calculation procedure 471 through the first operation path 451 and the second operation path 452, and guides the operation result (the intermediate data) from an output end of the addition circuit module 430 to an input end of the selection circuit module 410 through the first data reuse path 461 and the second data reuse path 462 for subsequent use of the second logical calculation procedure 472. Through this design, the same approximate operation circuit module 110 may be used again to take an output of the first logical calculation procedure 471 as an input of the second logical calculation procedure 472, and to complete the data processing procedure of the Softmax function approximation method through the operation paths (453, 454, and 455) corresponding to the second logical calculation procedure 472. This design manner helps to improve hardware utilization, reduce hardware resource consumption, and improve overall operation performance.

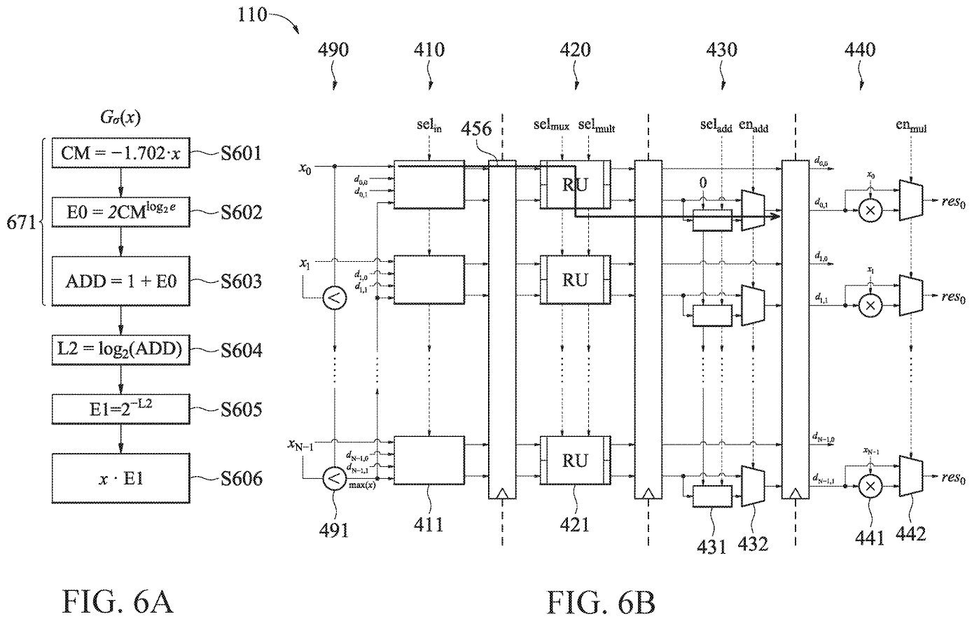

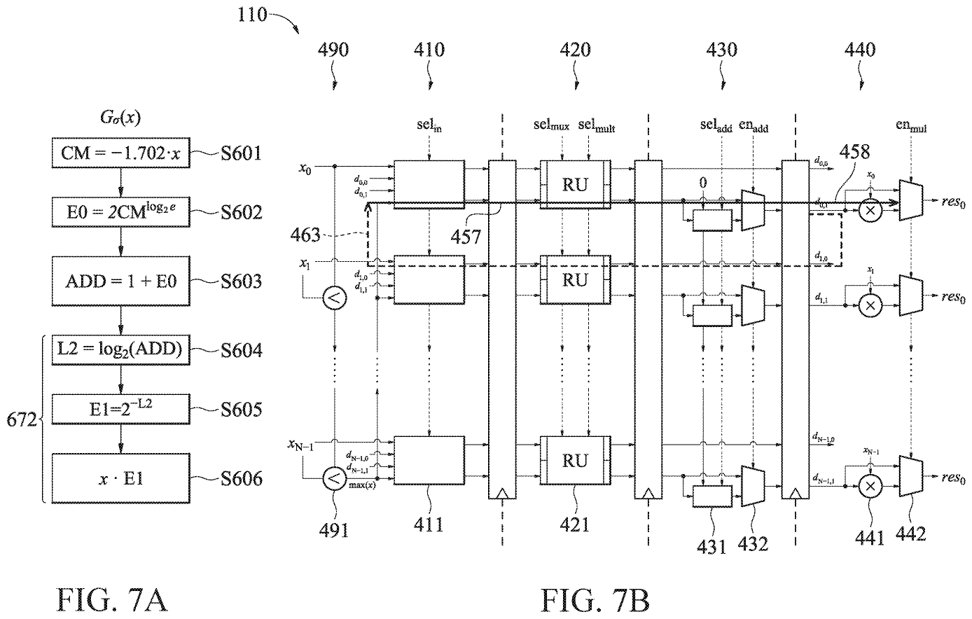

Refer to FIG. 6A to FIG. 7B simultaneously. FIG. 6A is a flowchart of a first logical calculation procedure of a data processing procedure of a GELU function according to an embodiment of the present invention. FIG. 6B is a schematic diagram of an operation path established by an approximate operation circuit module corresponding to a first logical calculation procedure of a GELU function according to an embodiment of the present invention. FIG. 7A is a flowchart of a second logical calculation procedure of a data processing procedure of a GELU function according to an embodiment of the present invention. FIG. 7B is a schematic diagram of an operation path established by an approximate operation circuit module corresponding to a second logical calculation procedure of a GELU function according to an embodiment of the present invention. In an embodiment, the present disclosure provides a nonlinear function processing apparatus 100, which may be applied to a neural network system, and implement an approximation method of a GELU function through an approximate operation circuit module 110, an approximate control module 120, and a data guidance module 130. A GELU function approximation method aims to reduce complexity of the GELU function when implemented in hardware. The GELU function approximation method is based on a Sigmoid function, and a corresponding formula may be expressed as:

$$G E L {U}_{σ} ( x ) = x \cdot σ ( 1.702 x )$$

where σ(x) represents a Sigmoid function. To reduce complexity of the GELU function approximation method when implemented in hardware, a formula corresponding to the GELU function is transformed in a logarithmic-exponential reciprocal form, to implement a required operation through a low-complexity operation circuit component. A corresponding formula of the logarithmic-exponential reciprocal form of the GELU function may be expressed as:

$${G}_{σ} ( x ) = \frac{1}{1 + {e}^{- 1.702 x}} = x \cdot {2}^{- l o {g}_{2} ( 1 + {e}^{- 1.702 x} )}$$

A plurality of calculation formulas (or calculation steps) included in the data processing procedure corresponding to the GELU function may be inferred according to the logarithmic-exponential reciprocal form of the GELU function, and these calculation formulas (or calculation steps) may implement the GELU function approximation method only by operation forms such as addition, subtraction, multiplication, a binary exponential function, and a binary logarithmic function. In this way, the shared circuit structure of the approximate operation circuit module 110 is designed by only using a low-complexity circuit component. A binary logarithmic operator and a binary exponential operator that are designed according to a binary logarithmic approximate formula and a binary exponential approximate formula and are proposed in the present invention may be integrated into the approximate operation circuit module 110, thereby improving operation efficiency and reducing power consumption.

As shown in FIG. 6A and FIG. 7A, the logarithmic-exponential reciprocal form of the GELU function may be applied to inferring a plurality of calculation formulas (or calculation steps), that is, step S601 to step S606. The data processing procedure corresponding to the GELU function includes a first logical calculation procedure 671 and a second logical calculation procedure 672. The first logical calculation procedure 671 corresponds to step S601 to step S603. By analyzing step S601 to step S603, a group of control signals corresponding to the first logical calculation procedure 671 may be obtained for controlling a circuit component in the approximate operation circuit module 110 to dynamically establish at least one operation path, thereby executing operations corresponding to step S601 to step S603. Similarly, the second logical calculation procedure 672 corresponds to step S604 to step S606. By analyzing step S604 to step S606, a group of control signals corresponding to the second logical calculation procedure 672 may be obtained for controlling a circuit component in the approximate operation circuit module 110 to dynamically establish at least one operation path, thereby executing operations corresponding to step S604 to step S606.

The GELU function approximation method is to perform an operation on the input data and generate a corresponding operation result according to the data processing procedure designed in the logarithmic-exponential reciprocal form, including a plurality of calculation formulas (or calculation steps) executed sequentially. In other words, the data processing procedure corresponding to the GELU function approximation method includes a plurality of steps (steps S601 to S606). Various steps are described as follows:
Step S601: CM=−1.702·x. This step is used for calculating an intermediate variable CM. An input value is multiplied by an optimal constant −1.702, to obtain the intermediate variable CM. The optimal constant may be obtained through an experiment or approximate fitting, which is used for effectively reducing an error between a Sigmoid function and a cumulative distribution function Φ(x) in a standard normal distribution.
Step S602: E0=2^{CM·log}^{₂}^{e}. A natural exponential function eCM is transformed into an equivalent expression 2^{CM·log}^{₂}^{e}, thereby facilitating implementing a low-complexity circuit component. In an implementation, CM·log₂ e is calculated through a multiplier first, and then a corresponding exponential value E0 is obtained by using a binary exponential operator.
Step S603: ADD=1+E0. A constant 1 is added to the exponential value E0 obtained in step S602 to obtain ADD. This step is used for implementing the equivalent expression of 1+e^{-1.702x}.
Step S604: L2=log₂(ADD). A logarithm with a base of 2 is taken for the ADD obtained in step S603, to transform division required by the original GELU function into subtraction and an exponential operation, thereby facilitating a subsequent operation. In an implementation, an exponential value L2=log₂(ADD) corresponding to the ADD may be obtained through a binary logarithmic operator.
Step S605: E1=2^{-L2}. A logarithmic value obtained in step S604 is reversed back to an exponential domain. In an implementation, a negative value is taken for the logarithmic value L2 first (a symbol of L2 is reversed), and an exponential value E1 corresponding to the negative value is obtained through the binary exponential operator. This step is used for implementing an output value 2^{-log}^{₂}^{(1+e}^{_{−1.702x)}} of the Sigmoid function.
Step S606: x·E1. The input value x is multiplied by the exponential value E1 obtained in step S605, to obtain the output value

$${G}_{σ} ( x ) = x \cdot {2}^{- l o {g}_{2} ( 1 + {e}^{- 1.702 x} )}$$

of the GELU function approximation method.

In the data processing procedure corresponding to the GELU function, for the operations of a binary logarithm and a binary exponent, the binary logarithmic operator and the binary exponential operator that are designed according to the binary logarithmic approximate formula: log₂ x≈ω+ (k−1) and the binary exponential approximate formula 2^{x}≈(1+x_{frac}). 2^{x}^{ᵢₙₜ} and are proposed in the present invention may be used, thereby reducing operation complexity.

In an embodiment, the approximate operation circuit module 110 of the nonlinear function processing apparatus 100 includes a shared circuit structure formed by a selection circuit module 410, a reconfigurable circuit module 420, an addition circuit module 430, and a multiplication circuit module 440, and is configured to enable a GELU operation module 112 to execute an operation corresponding to the GELU function. The data processing procedure corresponding to the GELU operation module 112 includes a plurality of logical calculation procedures. Each logical calculation procedure corresponds a group of control signals, to dynamically establish at least one operation path in the approximate operation circuit module 110 according to this group of control signals. These operation paths corresponding to the logical calculation procedures may operate independently or in parallel in the approximate operation circuit module 110, to execute operations required by the calculation formulas (or the calculation steps) corresponding to various logical calculation procedures.

In an embodiment, by analyzing step S601 to step S603 (that is, the first logical calculation procedure 671) and step S604 to step S606 (that is, the second logical calculation procedure 672) of the data processing procedure of the GELU function approximation method, a group of corresponding control signals can be separately obtained for controlling the approximate operation circuit module 110 to execute corresponding operations. According to the control signals corresponding to the first logical calculation procedure 671, the approximate operation circuit module 110 may dynamically establish a sixth operation path 456 in the shared circuit structure of the approximate operation circuit module 110, and execute corresponding operations through circuit components on these operation paths, to obtain calculation results of step S601 to step S603. In short words, the first logical calculation procedure 671 shown in FIG. 6A corresponds to an operation path (456) shown in FIG. 6B. Similarly, according to the control signals corresponding to the first logical calculation procedure 672, the approximate operation circuit module 110 may dynamically establish a seventh operation path 457 and an eighth operation path 458 in the shared circuit structure of the approximate operation circuit module 110, and execute corresponding operations through circuit components on these operation paths, to obtain calculation results of step S604 to step S606. In short words, the second logical calculation procedure 672 shown in FIG. 7A corresponds to operation paths (457 and 458) shown in FIG. 7B.

As shown in FIG. 7B, to meet a demand of reusing intermediate data in the GELU function approximation method, a calculation result (intermediate data) of the first logical calculation procedure 671 may be provided for the second logical calculation procedure 672 for subsequent use through at least one data reuse path in the approximate operation circuit module 110. The approximate operation circuit module 110 provides a third data reuse path 463. The first logical calculation procedure 671 obtains the calculation result (the intermediate data) of the first logical calculation procedure 671 through the sixth operation path 456, and guides the calculation result (the intermediate data) from an output end of the addition circuit module 430 to an input end of the selection circuit module 410 through the third data reuse path 463 for subsequent use of the second logical calculation procedure 672. Through this design, the same approximate operation circuit module 110 may be used again to take an output of the first logical calculation procedure 671 as an input of the second logical calculation procedure 672, and complete the data processing procedure of the GELU function approximation method through the operation paths (457 and 458) corresponding to the second logical calculation procedure 672. This design manner helps to improve hardware utilization, reduce hardware resource consumption, and improve overall operation performance.

In an embodiment, the square root function approximation method is a data processing procedure designed according to a logarithmic-exponential reciprocal form. The data processing procedure of the square root function includes at least one logical calculation procedure. The logical calculation procedure includes a plurality of steps of the data processing procedure of the square root function. At least one operation path may be dynamically established in the approximate operation circuit module 110 through the control signal corresponding to the logical calculation procedure. An approximate operation is performed on input data through the at least one operation path. In other words, the square root function approximation method may be implemented through a combination operation of the binary logarithmic operator and the binary exponential operator that are designed according to the binary logarithmic approximate formula and the binary exponential approximate formula and are proposed by the present invention.

Refer to FIG. 4A to FIG. 7B below simultaneously. In an embodiment, the nonlinear function processing apparatus 100 may be applied to executing data processing procedures corresponding to a plurality of nonlinear functions (for example, a Softmax function, a GELU function, and a square root function). The nonlinear function processing apparatus 100 implements operations of a plurality of nonlinear function approximation methods through the shared circuit structure of the approximate operation circuit module 110. This design method has advantages of high operation efficiency and excellent approximation quality simultaneously. Compared with a traditional method of constructing an exclusive circuit for each of the Softmax function, the GELU function, or the square root function, the shared circuit architecture of the approximate operation circuit module 110 can significantly improve hardware resource use efficiency and calculation elasticity. This design is particularly suitable for an AI model that needs to process a plurality of nonlinear functions simultaneously and have limited hardware resources, and can alternatively serve as an acceleration solution for an AI hardware platform.

The approximate operation circuit module 110 includes: a selection circuit module 410, a reconfigurable circuit module 420, an addition circuit module 430, and a multiplication circuit module 440. The selection circuit module 410 is electrically connected to the reconfigurable circuit module 420, the reconfigurable circuit module 420 is electrically connected to the addition circuit module 430, and the addition circuit module 430 is electrically connected to the multiplication circuit module 440. The selection circuit module 410, the reconfigurable circuit module 420, the addition circuit module 430, and the multiplication circuit module 440 jointly form the shared circuit structure of the approximate operation circuit module 110.

In an embodiment, the approximate operation circuit module 110 further includes a comparison circuit module 490. The comparison circuit module 490 is electrically connected to the selection circuit module 410. The comparison circuit module 490 includes a plurality of comparators 491 that are electrically connected. The comparison circuit module 490, the selection circuit module 410, the reconfigurable circuit module 420, the addition circuit module 430, and the multiplication circuit module 440 jointly form the shared circuit structure of the approximate operation circuit module 110, which may be configured to complete operations corresponding to the Softmax operation module 111, the GELU operation module 112, and the square root operation module 113.

In an embodiment, the shared circuit structure of the approximate operation circuit module 110 may be adjusted or extended according to an application requirement (or operation scale). The selection circuit module 410 includes a plurality of selector units 411 that are electrically connected. The reconfigurable circuit module 420 includes a plurality of reconfigurable units 421 that are electrically connected. The addition circuit module 430 includes a plurality of adders 431 that are electrically connected and a plurality of addition enabling selectors 432, and these adders 431 are electrically connected to these addition enabling selectors 432. The multiplication circuit module 440 includes a plurality of multipliers 441 that are electrically connected and a plurality of multiplication enabling selectors 442, and these multipliers 441 are electrically connected to these multiplication enabling selectors 442. Quantities of the multiplier units 411, the reconfigurable units 421, the adders 431, and the multipliers 441 may be arbitrarily configured, for example, 4, 16, 32, 64, 128, or more, to form the shared circuit structure of the approximate operation circuit module 110, thereby supporting approximate operations of diversified nonlinear functions.

In an embodiment, control signals are used for controlling running of specific circuit components in the approximate operation circuit module 110 (for example, the selection circuit module 410, the reconfigurable circuit module 420, the adder 431, the addition enabling selector 432, and the multiplication enabling selector 442). These circuit components are provided with corresponding input ends, and are configured to receive control signals and execute corresponding operations according to the received control signals. The control signals corresponding to various circuit components may form a group of control signals, and are used for triggering and executing a group of logical operations. In an embodiment, the control signal may be generated by a Finite State Machine (FSM), a micro-coded control unit, and another control logical module, thereby dynamically configuring the shared circuit structure in the approximate operation circuit module 110 according to a predetermined logical process or operation mode. In an embodiment, these control signals may further control a multiplexer, clock gating logic, circuit enable signals, or a data path configuration module to selectively enable a specific circuit block or guide operation data to flow in a specific operation path.

In an embodiment, the control signals are used for controlling specific circuit components in the approximate operation circuit module 110. The control signals include: a selector control signal selᵢₙ, a selection control signal selₘᵤₓ, a multiplication control signal selₘᵤₗₜ, an adder control signal sel_{add}, an adder enabling signal en_{add}, and a multiplier enabling signal enₘᵤₗ. The selector control signal selᵢₙ is used for controlling the selection circuit module 410. The selection control signal selₘᵤₓ and the multiplication control signal selₘᵤₗₜ are used for controlling the reconfigurable circuit module 420. The adder control signal sel_{add} is used for controlling the adder 431 in the addition circuit module 430. The adder enabling signal en_{add} is used for controlling the addition enabling selector 432 in the addition circuit module 430. The multiplier enabling signal enₘᵤₗ is used for controlling the multiplication enabling selector 442 in the multiplication circuit module 440.

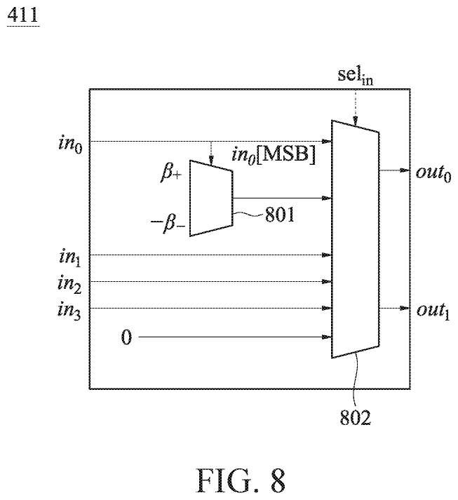

FIG. 8 is a circuit diagram of a selector unit 411 of an approximate operation circuit module 110 according to an embodiment of the present invention. In an embodiment shown in FIG. 8, the selector unit 411 has a plurality of input ends and a plurality of output ends, and includes a first selector 801 and a second selector 802. The first selector 801 includes a first input end and a second input end that are configured to respectively input a positive value and a negative value of an operand β. A selection end of the first selector 801 is configured to input an MSB of input data. An output end of the first selector 801 is configured to output a selection result of the first selector 801 according to the MSB (that is, data of a first end or a second end of the first selector 801). The second selector 802 includes a plurality of input ends that are electrically connected to a plurality of input ends (in₀, in₁, in₂, in₃) of the selector unit 411 and are configured to input the input data. One of the plurality of input ends (for example, in₀) is configured to input the MSB of the input data, and another of the plurality of input ends (for example, in₃) is configured to input the MSB of the input data. In addition, the plurality of input ends of the second selector 802 further include an input end for inputting the selection result of the first selector 801, and an input end with a logical value of 0. A selection end of the second selector 802 is configured to input a control signal (a selector control signal selᵢₙ). The second selector 802 includes a second output end that is electrically connected to a plurality of output ends (out₀, out₁) of the selector unit 411 and is configured to output the selection result of the second selector 802 according to the control signal.

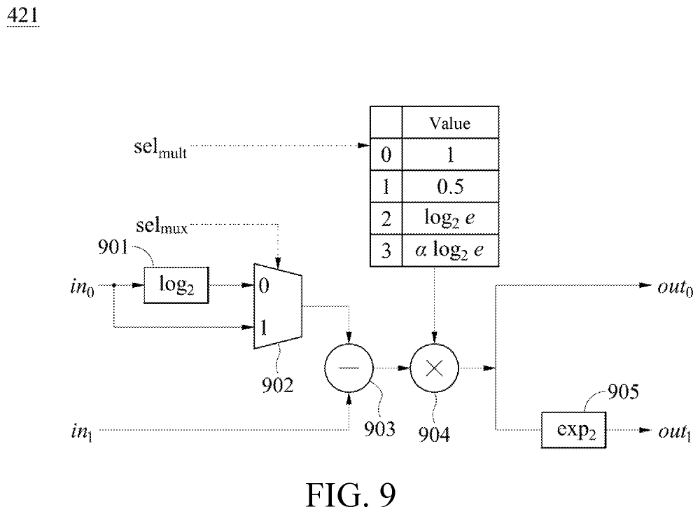

FIG. 9 is a circuit diagram of a reconfigurable unit 421 of an approximate operation circuit module 110 according to an embodiment of the present invention. In an embodiment shown in FIG. 9, the reconfigurable unit 421 has a plurality of input ends and a plurality of output ends, and includes a binary logarithmic operator 901, a third selector 902, a first subtractor 903, a first multiplier 904, and a binary exponential operator 905. Two input ends (in₀, in₁) of the reconfigurable unit 421 are electrically connected to two output ends (out₀, out₁) of the selector unit 411. The binary logarithmic operator 901 is electrically connected to the first input end (in₀) of the reconfigurable unit 421, and is configured to input data input into the first input end (in₀) of the reconfigurable unit 421 and output an operation result of a binary logarithmic operation. The third selector 902 is electrically connected to the second input end (in₁) of the reconfigurable unit 421, includes a first input end and a second input end that are respectively configured to input an operation result of the binary logarithmic operator 901 and data of the second input end (in₁) of the reconfigurable unit 421. A selection end of the third selector 902 is configured to input a control signal (a selection control signal selₘᵤₓ). An output end of the third selector 902 is configured to output a selection result of the third selector 902 according to the control signal (that is, data of a first end or a second end of the third selector 902). The first subtractor 903 includes a first input end and a second input end that are respectively configured to input the selection result of the third selector 902 and the data of the second input end (in₁) of the reconfigurable unit 421, and output an operation result of the first subtractor 903. The first multiplier 904 electrically includes a first input end and a second input end that are respectively configured to input the operation result of the first subtractor 903 and a value of a multiplication operation corresponding to the control signal (the multiplication control signal selₘᵤₗₜ), and output the operation result of the first multiplier 904 to the first output end (out₀) of the reconfigurable unit 421 and the binary exponential operator. The binary exponential operator is configured to input the operation result of the first multiplier 904, and output the operation result of the binary exponential operator to the second output end (out₁) of the reconfigurable unit 421. The first output end (out₀) and the second output end (out₁) of the reconfigurable unit 421 are respectively electrically connected to the first multiplier 904 and the binary exponential operator.

In an embodiment, the binary logarithmic operator 901 in the reconfigurable unit 421 is a circuit component designed through a binary logarithmic function approximation method. Preferably, the binary logarithmic operator 901 is a circuit designed according to a binary logarithmic approximate formula: log₂ x≈ω+(k−1), thereby reducing operation complexity and operation costs of the binary logarithmic operator. Similarly, the binary exponential operator 905 of the reconfigurable unit 421 is a circuit component designed through a binary exponential function approximation method. Preferably, the binary exponential operator 905 is a circuit designed according to a binary exponential approximate formula: 2^{x}≈(1+x_{frac})·2^{x}^{ᵢₙₜ}, thereby reducing operation complexity and operation costs of the binary exponential operator.

In an embodiment, the control signals corresponding to the logical calculation procedures may be used for controlling whether to enable the addition circuit module 430 (for example, through the addition enabling selector 432) and the multiplication circuit module 440 (for example, through the multiplication enabling selector 442) of the approximate operation circuit module 110. In addition, the control signals corresponding to the logical calculation procedures may alternatively be used for controlling operations of specific circuit components in the approximate operation circuit module 110, so as to form operation paths or data processing paths among these circuit components. For example, the operation paths or data processing paths are implemented through the second selector 802 in the selector unit 411 of the reconfigurable circuit module 420, or through the third selector 902 and the first multiplier 904 in the reconfigurable unit 421 of the reconfigurable circuit module 420.

In an embodiment, the corresponding control signal in the reconfigurable unit 421 includes a selection control signal selₘᵤₓ and a multiplication control signal selₘᵤₗₜ that are used for respectively controlling the third selector 902 and the first multiplier 904 in the reconfigurable unit 421. The selection control signal selₘᵤₓ is used for determining whether a data processing path in the reconfigurable unit 421 includes the binary logarithmic operator 901. The multiplication control signal selₘᵤₗₜ is used for determining a value of a multiplication operand input into the first multiplier 904. In an embodiment, when the multiplication control signal selₘᵤₗₜ is 0, the value of the multiplication operand corresponding to the first multiplier 904 is 1; when the multiplication control signal selₘᵤₗₜ is 1, the value of the multiplication operand corresponding to the first multiplier 904 is 0.5; when the multiplication control signal selₘᵤₗₜ is 2, the value of the multiplication operand corresponding to the first multiplier 904 is log₂ e; and when the multiplication control signal selₘᵤₗₜ is 3, the value of the multiplication operand corresponding to the first multiplier 904 is α·log₂ e.

In addition, in the nonlinear function operation, the approximate control module 120 generates at least one setting of a corresponding control signal according to the nonlinear function approximation method, to establish at least one operation path in the approximate operation circuit module 110. In an embodiment, when an operation of the Softmax function approximation method is performed, the approximate control module 120 analyzes the first logical calculation procedure 471 of the data processing procedure of the Softmax function to generate a first setting of the control signal (that is, a group of control signals corresponding to the first logical calculation procedure 471), to establish a first operation path 451 and a second operation path 452 in the approximate operation circuit module 110. In the first setting of the control signal, the selection control selₘᵤₓ in the reconfigurable circuit module 420 is set to 1 and the multiplication control signal selₘᵤₗₜ is set to 2. Similarly, the approximate control module 120 analyzes the second logical calculation procedure 472 of the data processing procedure of the Softmax function to generate a second setting of the control signal (that is, a group of control signals corresponding to the second logical calculation procedure 472), to establish a third operation path 453, a fourth operation path 454, and a fifth operation path 455 in the approximate operation circuit module 110. In the second setting of the control signal, the selection control signal selₘᵤₓ in the reconfigurable circuit module 420 is set to 0 and the multiplication control signal selₘᵤₗₜ is set to 0.

In an embodiment, when an operation of the GELU function approximation method is performed, the approximate control module 120 analyzes the first logical calculation procedure 671 of the data processing procedure of the GELU function, to obtain a first setting of the control signal (that is, a group of control signals corresponding to the first logical calculation procedure 671), to establish a sixth operation path 456 in the approximate operation circuit module 110. In the first setting of the control signal, the selection control selₘᵤₓ in the reconfigurable circuit module 420 is set to 1 and the multiplication control signal selₘᵤₗₜ is set to 3. Similarly, the approximate control module 120 analyzes the second logical calculation procedure 672 of the data processing procedure of the GELU function to generate a second setting of the control signal (that is, a group of control signals corresponding to the second logical calculation procedure 672), to establish a seventh operation path 457 in the approximate operation circuit module 110. In the second setting of the control signal, the selection control signal selₘᵤₓ in the reconfigurable circuit module 420 is set to 0 and the multiplication control signal selₘᵤₗₜ is set to 0.

In an embodiment, when an operation of a square root function is performed, the approximate control module 120 analyzes the data processing procedure of the square root function to obtain a corresponding control signal, to establish at least one corresponding operation path in the approximate operation circuit module 110. The selection control signal selₘᵤₓ in the reconfigurable circuit module 420 is set to 0 and the multiplication control signal is set to 1.

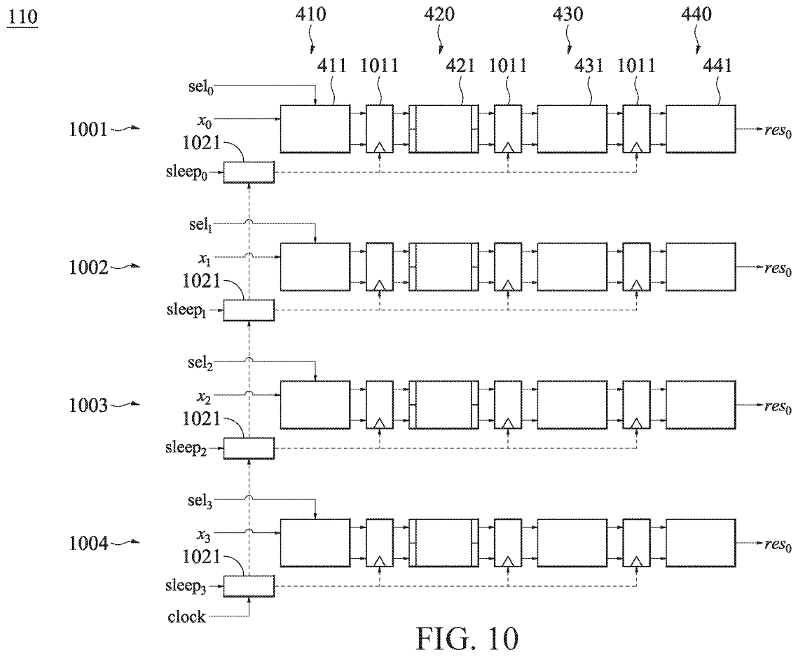

FIG. 10 is a circuit diagram of a register unit 1011 of an approximate operation circuit module 110 according to an embodiment of the present invention. The approximate operation circuit module 110 includes a plurality of approximate operation circuit units (1001, 1002, 1003, and 1004). Each approximate operation circuit unit (1001, 1002, 1003, or 1004) includes a selector unit 411, a reconfigurable unit 421, an adder 431, a multiplier 441, a clock gating controller 1021, and a plurality of register units 1011. The plurality of register units 1011 are respectively and electrically connected between the selector unit 411 and the reconfigurable unit 421, between the reconfigurable unit 421 and the adder 431, and between the adder 431 and the multiplier 441. The clock gating controller 1021 is electrically connected to these register units 1011, and is configured to gate clock signals of these register units 1011 through sleep signals corresponding to the clock gating controller 1021. In other words, when the sleep signals are input into the clock gating controller 1021, the clock gating controller 1021 controls these register units 1011 to enter a low-power consumption state. In an embodiment, if only the second operation circuit unit needs to be run, sleep signals (sleep₀, sleep₁) input into the clock gating controller 1021 corresponding to the approximate operation circuit units (1001, 1002) are set to 0, and sleep signals (sleep₂, sleep₃) input into the clock gating controller 1021 corresponding to the approximate operation circuit units (1003, 1004) are set to 1, so that data update does not need to be performed on the register units 1011 of the approximate operation circuit units (1003, 1004), thereby effectively reducing power consumption. Preferably, the register unit 1011 may be a pipeline register.

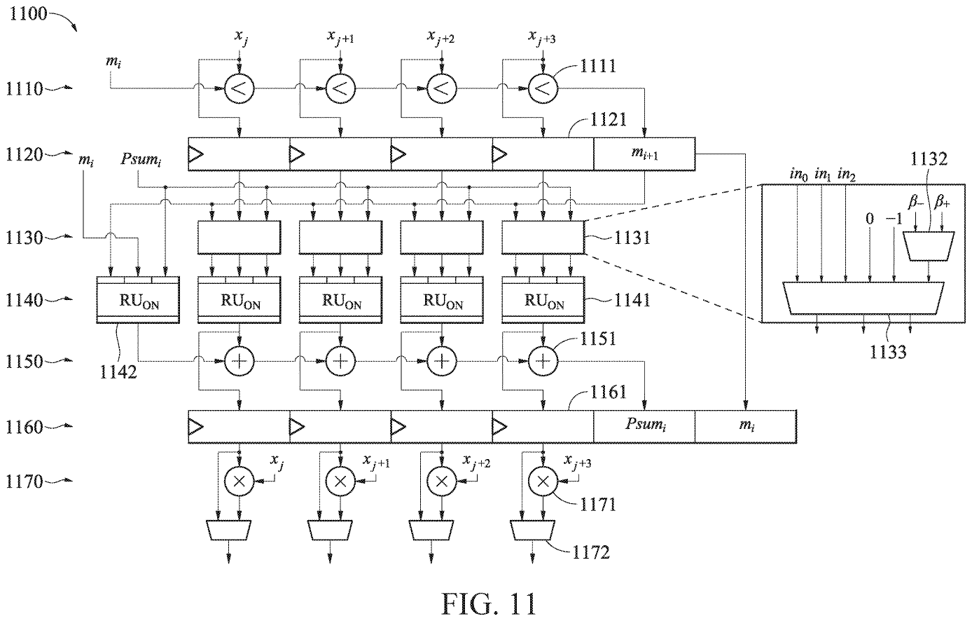

FIG. 11 is a circuit diagram of an approximate operation circuit module according to an embodiment of the present invention. Traditionally, an online normalization technology involves online update operations, and the operation of a nonlinear function usually needs to be additionally configured with calculation resources, so the online normalization technology has not been applied to a reconfigurable circuit architecture. In an embodiment shown in FIG. 11, an approximate operation circuit module 1100 is another embodiment of the foregoing approximate operation circuit module 110. A shared circuit structure of the approximate operation circuit module 1100 can support operations corresponding to approximation methods of a Softmax function and a GELU function based on the online normalization technology. The shared circuit structure of the approximate operation circuit module 1100 is designed by using a low-complexity circuit component, thereby reducing operation costs and improving operation efficiency. The nonlinear function processing apparatus 100 can implement operations of a plurality of nonlinear function approximation methods through the shared circuit structure of the approximate operation circuit module 1100.

In the embodiment shown in FIG. 11, the approximate operation circuit module 1100 includes: a comparison circuit module 1110, a first register module 1120, a selection circuit module 1130, a reconfigurable circuit module 1140, an addition circuit module 1150, a second register module 1160, and a multiplication circuit module 1170. The comparison circuit module 1110 includes a plurality of comparators 1111 that are electrically connected and are configured to input data elements (that is, xⱼ, xⱼ₊₁, xⱼ₊₂, and xⱼ₊₃) corresponding to a data subset segmented from input data and a reference value (that is, mᵢ), and output a comparison result of the comparison circuit module 1110. The first register module 1120 includes a plurality of first register units 1121. The first register unit 1121 is configured to store the data elements corresponding to the data subset. The selection circuit module 1130 includes a plurality of selector units 1131. The selector unit 1131 is configured to input output data of the first register unit 1121, a comparison result of the comparison circuit module 1110, and an accumulation result of the addition circuit module 1150, and output a selection result of the selector unit 1131. The reconfigurable circuit module 1140 includes a plurality of reconfigurable units 1141. The reconfigurable unit 1141 is configured to input a selection result of the selection circuit module 1130, and output an operation result of the reconfigurable unit 1141. The addition circuit module 1150 includes a plurality of adders that are electrically connected and are configured to input an operation result of the reconfigurable unit 1142 and operation results of various reconfigurable units 1141, and output an accumulation result of the addition circuit module 1150. The second register module 1160 includes a plurality of second register units 1161. The second register unit 1161 is configured to store an operation result of the reconfigurable unit 1141. The multiplication circuit module 1170 includes a plurality of multipliers 1171 and a plurality of multiplication enabling selectors 1172. The multiplier 1171 is configured to input output data of the second register unit 1161 and the data elements corresponding to the data subset, and output a byproduct result of the multiplier 1171. The multiplication enabling selector 1172 is configured to input output data of the second register unit 1161 and the byproduct result of the multiplier 1171, and outputs a selection result of the multiplication enabling selector 1172. The shared circuit structure of the approximate operation circuit module 1100 may be configured to implement operations corresponding to the Softmax operation module 111, the GELU operation module 112, and the square root operation module 113.

In an embodiment, the comparison circuit module 1110 is configured to perform comparison operations through the plurality of comparators 1111, and output a comparison result of the comparison circuit module 1110 (that is, a maximum value miti of the corresponding data elements in the data subset obtained after these comparators 1111 perform the comparison operation one by one). For example, a first input end of the comparator 1111 is configured to input various data elements corresponding to the data subset; a second input end of the comparator 1111 is configured to input a comparison result of an output end of the previous comparator 1111; and an input end of the comparator 1111 is configured to output the comparison result of the comparator 1111 to the second input end of the next comparator 1111. The first register module 1120 is configured to store the data elements (that is, xⱼ, xⱼ₊₁, xⱼ₊₂, and xⱼ₊₃) corresponding to the data subset, and store the comparison result (that is, mᵢ₊₁) of the comparison circuit module 1110. The second register module 1160 is configured to store operation results of the plurality of reconfigurable units 421, store an accumulation result of the addition circuit module 1150 (that is, a sum value Psumᵢ obtained after these adders perform accumulation operations one by one), and store an operation result (that is, mᵢ₊₁) of the comparison circuit module 1110 stored in the first register module 1120, and may be configured to calculate a reference value (that is, mᵢ) required by the next data subset.

In an embodiment, a quantity of the reconfigurable units 1141 configured in the reconfigurable circuit module 1140 is one more (that is, the reconfigurable unit 1142) than the selector units 1131 configured in the selection circuit module 1130, the adders 1151 configured in the addition circuit module 1150, and the multipliers 1171 configured in the multiplication circuit module 1170. The reconfigurable unit 1142 and the reconfigurable unit 1141 have the same circuit design, and are configured to execute a recursive update operation to dynamically update the maximum value mᵢ₊₁ of the corresponding data elements in the data subset obtained after these comparators 1111 perform the comparison operations one by one, the reference value (that is, mᵢ), and the sum value Psumᵢ obtained after these adders 1151 perform the accumulation operations one by one, thereby meeting an update demand on the intermediate data required when various data subsets are processed in batches.

In an embodiment, the selector unit 1131 in the approximate operation circuit module 1100 has a plurality of input ends and a plurality of output ends, and includes a first selector 1132 and a second selector 1133 that are electrically connected. The first selector 1132 includes a first input end and a second input end that are configured to respectively input a positive value and a negative value of an operand β, and output a selection result of the first selector 1132 (that is, data of a first end or a second end of the first selector 1132). The second selector 1133 includes a plurality of input ends that are respectively electrically connected to a plurality of input ends (in₀, in₁, in₂) of the selector unit 1131, to input corresponding data. In addition, the second selector 1133 further includes an input end with a logical value of 0, an input end with a logical value of 1, and an input end configured to input the selection result of the first selector 1132. The second selector 1133 includes three output ends that are respectively electrically connected to the plurality of output ends of the selector unit 1131 and configured to output the selection result of the second selector 1133. In an embodiment, each output end of the second selector 1133 may individually select, according to independent control signals (selector control signals), corresponding input ends as output sources to output corresponding data values, for example, a positive value or a negative value of the operand β, a data value of 0 or 1, and a data value of in₀, in₁, or in₂.

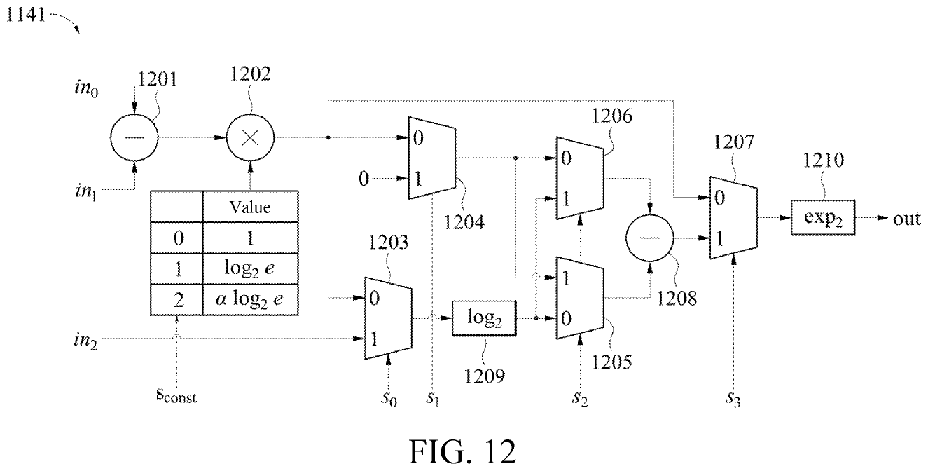

Refer to FIG. 12 below. FIG. 12 is a circuit diagram of a reconfigurable unit 1141 of an approximate operation circuit module 1100 according to an embodiment of the present invention. In an embodiment shown in FIG. 12, the reconfigurable unit 1141 in the reconfigurable circuit module 1140 of the approximate operation circuit module 1100 has three input ends and an output end. The three input ends of the reconfigurable unit 1141 are configured to respectively input input data, a maximum value, and a sum value; and the output end of the reconfigurable unit 1141 is configured to output an operation result of the reconfigurable unit 1141. The reconfigurable unit 1141 includes circuit components such as a first subtractor 1201, a first multiplier 1202, a third selector 1203, a fourth selector 1204, a binary logarithmic operator 1209, a fifth selector 1205, a sixth selector 1206, a second subtractor 1208, a seventh selector 1207, and a binary exponential operator 1210.

The first subtractor 1201 of the reconfigurable unit 1141 includes a first input end and a second input end that are respectively configured to input data of the first input end (in₀) and the second input end (in₁) of the reconfigurable unit 1141, and output an operation result of the first subtractor 1201.

The first multiplier 1202 of the reconfigurable unit 1141 includes a first input end and a second input end that are respectively configured to input the operation result of the first subtractor 1201 and a value of a multiplication operation corresponding to the multiplication control signal (s_{const}), and output an operation result of the first multiplier 1202.

The third selector 1203 of the reconfigurable unit 1141 includes a first input end and a second input end that are respectively configured to input an operation result of the first multiplier 1202 and data of the third input end (in₂) of the reconfigurable unit 1141. A selection end of the third selector 1203 is configured to input a control signal (s₀). An output end of the third selector 1203 is configured to output a selection result (that is, data of a first end or a second end of the third selector 1203) of the third selector 1203 according to the control signal (s₀).

The fourth selector 1204 of the reconfigurable unit 1141 includes a first input end and a second input end that are respectively configured to input an operation result of the first multiplier 1202 and the value with the logical value of 0. A selection end of the fourth selector 1204 is configured to input a control signal (s₁). An output end of the fourth selector 1204 is configured to output a selection result (that is, data of a first end or a second end of the fourth selector 1204) of the fourth selector 1204 according to the control signal (s₁).

The binary logarithmic operator 1209 of the reconfigurable unit 1141 is configured to input the selection result of the third selector 1203, and output the operation result of the binary logarithmic operator 1209.

The fifth selector 1205 of the reconfigurable unit 1141 includes a first input end and a second input end that are respectively configured to input an operation result of the binary logarithmic operator 1209 and a selection result of the fourth selector 1204. A selection end of the fifth selector 1205 is configured to input a control signal (s₂). An output end of the fifth selector 1205 is configured to output a selection result (that is, data of a first end or a second end of the fifth selector 1205) of the fifth selector 1205 according to the control signal (s₂).

The sixth selector 1206 of the reconfigurable unit 1141 includes a first input end and a second input end that are respectively configured to input the selection result of the fourth selector 1204 and the operation result of a binary logarithmic operation. A selection end of the sixth selector 1206 is configured to input the control signal (s₂). An output end of the sixth selector 1206 is configured to output a selection result (that is, data of a first end or a second end of the sixth selector 1206) of the sixth selector 1206 according to the control signal (s₂).

The second subtractor 1208 of the reconfigurable unit 1141 includes a first input end and a second input end that are respectively configured to input the selection result of the fifth selector 1205 and the selection result of the sixth selector 1206, and output an operation result of the second subtractor 1208.

The seventh selector 1207 of the reconfigurable unit 1141 includes a first input end and a second input end that are respectively configured to input the operation result of the first multiplier 1202 and the operation result of the second subtractor 1208. A selection end of the seventh selector 1207 is configured to input a control signal (s₃). An output end of the seventh selector 1207 is configured to output a selection result (that is, data of a first end or a second end of the seventh selector 1207) of the seventh selector 1207 according to the control signal (s₃).

The binary exponential operator 1210 of the reconfigurable unit 1141 is configured to input the selection result of the seventh selector 1207, and output the operation result of the binary exponential operator 1210 to the output end (out) of the reconfigurable unit 1141.

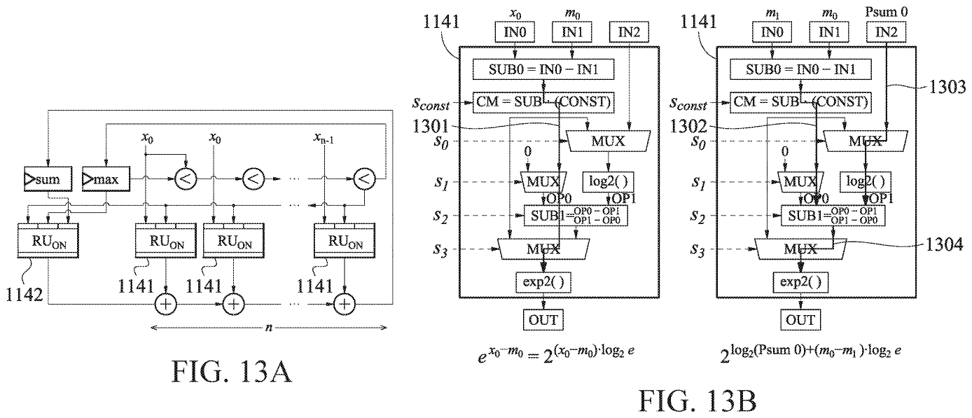

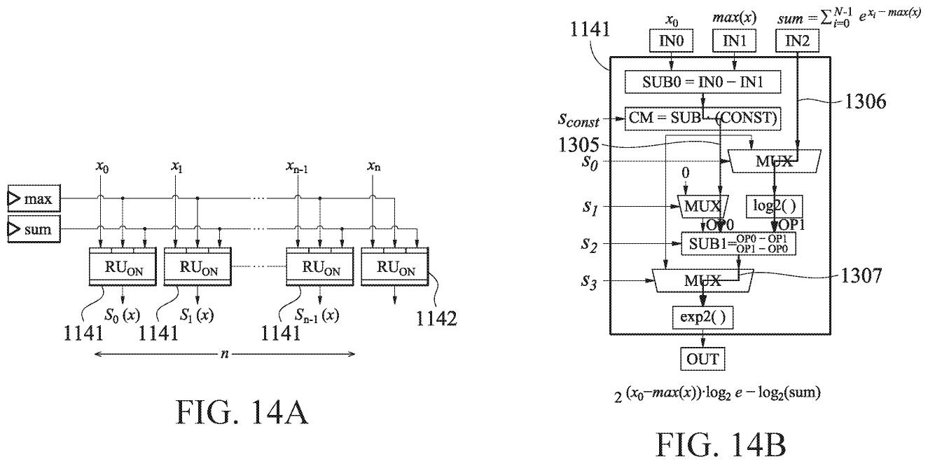

In an embodiment, the fifth selector 1205, the sixth selector 1206, and the second subtractor 1208 in the reconfigurable unit 1141 may be integrated into an integrated subtractor (for example, SUB 1 shown in FIG. 13B and FIG. 14B). The integrated subtractor may perform a corresponding difference operation on two groups of data at an input end according to a single control signal. For example, the integrated subtractor may perform a corresponding difference operation (that is, OP0-OP1 or OP1-OP0) on the operation result (for example: OP0) output by the fourth selector 1204 and an operation result (for example, OP1) output by the binary logarithmic operator 1209. By means of the integrated subtractor, hardware configuration in the reconfigurable unit 1141 can be simplified, and circuit complexity can be reduced.

In an embodiment, the binary logarithmic operator 1209 in the reconfigurable unit 1141 is a circuit implemented through the binary logarithmic function approximation method, for example, through a binary logarithmic approximate formula: log₂ x≈ω+(k−1), thereby reducing complexity and operation costs of the binary logarithmic function. The binary exponential operator 1210 of the reconfigurable unit 1141 is a circuit implemented through a binary exponential function approximation method, for example: the circuit designed according to the binary exponential function approximate formula 2^{x}=2^{x}^{ᵢₙₜ}^{+x}^{_{frac}}≈(1+x_{frac})·2^{x}^{ᵢₙₜ}, thereby reducing complexity and operation costs of the binary exponential function.

In an embodiment, the control signals corresponding to the reconfigurable unit 1141 include a multiplication control signal (s_{cons}) and selection control signals (s₀, s₁, s₂, s₃). The selection control signals (s₀, s₁, s₂, s₃) are used for determining data processing paths in the reconfigurable units 1141. The multiplication control signal (s_{cons}) is used for determining a value of a multiplication operand corresponding to the first multiplier 1202. In an embodiment, when the multiplication control signal (s_{cons}) is 0, the value of the multiplication operand corresponding to the first multiplier 1202 is 1; when the multiplication control signal (s_{cons}) is 1, the value of the multiplication operand corresponding to the first multiplier 1202 is log₂ e; and when the multiplication control signal (s_{cons}) is 2, the value of the multiplication operand corresponding to the first multiplier 1202 is α·log₂ e.

Refer to FIG. 13A to FIG. 14B below simultaneously. FIG. 13A is a schematic diagram of a first operation architecture of an approximate operation circuit module corresponding to a data processing procedure of a Softmax function according to an embodiment of the present invention. FIG. 13B is a schematic diagram of a data processing path established by a first operation architecture of an approximate operation circuit module corresponding to a data processing procedure of a Softmax function according to an embodiment of the present invention. FIG. 14A is a schematic diagram of a second operation architecture of an approximate operation circuit module corresponding to a data processing procedure of a Softmax function according to an embodiment of the present invention. FIG. 14B is a schematic diagram of a data processing path established by a second operation architecture of an approximate operation circuit module corresponding to a data processing procedure of a Softmax function according to an embodiment of the present invention.

As shown in FIG. 13A, in the first operation architecture of an approximate operation circuit module corresponding to a data processing procedure of a Softmax function, the reconfigurable unit 1142 is responsible for processing a recursive update operation. The input data to be processed by the Softmax function is usually vector data. A quantity (for example: N) of the data elements in the vector data may exceed an upper limit (for example: n) that the approximate operation circuit module 1100 can process, so the input data is segmented into a plurality of data subsets (for example: N/n), and the plurality of data subsets are processed by the approximate operation circuit module 1100 in turn in batches. In other words, the plurality of data subsets need to be executed repeatedly for N/n times to complete processing tasks of all data subsets (that is, the input data). When the approximate operation circuit module 1100 perform a plurality of rounds of processing in batches, an additionally configured reconfigurable unit 1142 may be used to execute the recursive update operation, to dynamically update an accumulation result (that is, sum) of the addition circuit module 1150 and dynamically update a comparison result (that is, max) of the comparison circuit module 1110, thereby meeting an update demand on the intermediate data when various data subsets are processed in batches in turn.

As shown in FIG. 14A, in a second operation architecture of an approximate operation circuit module corresponding to a data processing procedure of a Softmax function, an operation corresponding to a data processing procedure of the Softmax function is executed through the plurality of reconfigurable units 1141. The plurality of reconfigurable units 1141 (for example, n reconfigurable units 1141) are configured to input data elements (for example, x₀, x₁, . . . , xₙ₋₁) corresponding to the data subset, the comparison result (that is, max) of the comparison circuit module 1110, and the accumulation result (that is, sum) of the addition circuit module 1150, and perform an operation through at least one corresponding data processing path to output an output result (for example, S₀(x), S₁(x), . . . , Sₙ₋₁(x)) of the plurality of reconfigurable units 1141. In addition, the reconfigurable unit 1142 is configured to input data elements (for example: xₙ) corresponding to the next data subset, the comparison result (that is, max) of the comparison circuit module 1110, and the accumulation result (that is, sum) of the addition circuit module 1150.

In an embodiment shown in FIG. 13B and FIG. 14B, the data processing procedure designed by the Softmax function approximation method according to a logarithmic-exponential reciprocal form of the Softmax function includes at least one logical calculation procedure. Each logical calculation procedure includes corresponding calculation formulas (or calculation steps). Each logical calculation procedure corresponds a group of control signals, to dynamically establish at least one operation path in the approximate operation circuit module 1100 according to this group of control signals. The operation path may include at least one data processing path (for example, 1301 to 1307) in the reconfigurable unit 1141. These data processing paths are established through the control signals corresponding to the reconfigurable units 1141, thereby meeting different operation demands and achieving different objectives. The control signals corresponding to the reconfigurable unit 1141 include a multiplication control signal (s_{cons}) and selection control signals (s₀, s₁, s₂, s₃) that are respectively used for controlling operations of circuit components such as the multiplier (1202) and various selectors (1203 to 1207) in the reconfigurable unit 1141.

As shown in FIG. 13B, the data processing procedure of the first operation architecture of the approximate operation circuit module corresponding to the Softmax function includes two logical calculation procedures. Each logical calculation procedure may input corresponding data through three input ends (IN0, IN1, IN2) of the reconfigurable unit 1141 respectively to perform required operations. When input data is x₀ and m₀, the reconfigurable unit 1141 performs an operation of e^{x}^{₀}^{-m}^{₀}=2^{(x}^{₀}^{-m}^{₀}^{) log}^{₂}^{e} according to a corresponding control signal. The data processing path 1301 in the reconfigurable unit 1141 is used for calculating (x₀-m₀)·log₂ e. When input data is mᵢ, m₀, and Psum 0, the reconfigurable unit 1141 performs an operation of 2^{log}^{₂}^{(Psum 0)+(m}^{₀}^{-m}^{₁}^{) log}^{₂}^{e} according to corresponding control signals. The data processing path 1302 in the reconfigurable unit 1141 is used for calculating (m₀−m₁)·log₂ e; the data processing path 1303 is used for calculating log₂ (Psum 0); and the data processing path 1304 is used for calculating log₂ (Psum 0)+(m₀−m₁)·log₂ e.

As shown in FIG. 14B, the data processing procedure of the second operation architecture of the approximate operation circuit module corresponding to the Softmax function includes one logical calculation procedure, which inputs corresponding data through three input ends (IN0, IN1, IN2) of the reconfigurable unit 1141 respectively to perform the required operations. When input data is x₁, max(x), and

$$sum = {\sum }_{i = 0}^{N - 1} {e}^{{x}_{i} - max ( x )} ,$$

the reconfigurable unit 1141 performs an operation of 2^{(x}^{₀}^{-max(x))·log}^{₂}^{e-log}^{₂}^{(sum)} according to a corresponding control signal. The data processing path 1305 in the reconfigurable unit 1141 is used for calculating (x₀−max(x))·log₂ e; the data processing path 1306 is used for calculating log₂(sum); and the data processing path 1307 is used for calculating (x₀−max(x)·log₂ e−log₂(sum).

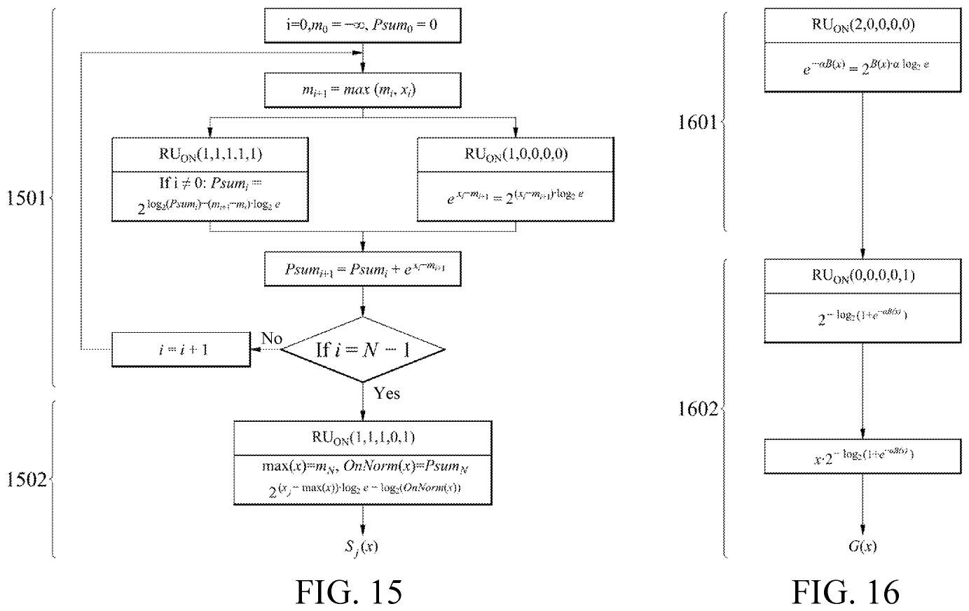

FIG. 15 is a flowchart of a data processing procedure of a Softmax function approximation method according to an embodiment of the present invention. In an embodiment shown in FIG. 15, the data processing procedure of the Softmax function approximation method includes a first stage 1501 and a second stage 1502. In the first stage 1501 of the Softmax function approximation method, two logical calculation procedures sequentially processed are included. One logical calculation procedure corresponds to a first setting of the control signal, for example, (s_{const}, s₀, s₁, s₂, s₃)=(1, 0, 0, 0, 0), and is used for enabling the reconfigurable unit 1141 to perform an operation e^{x}^{ᵢ}^{-m}^{ᵢ₊₁}=2^{(x}^{ᵢ}^{-m}^{ᵢ₊₁}^{)·log}^{₂}^{e} through a corresponding data processing path; and the other logical calculation procedure corresponds to a second setting of the control signal, for example, (s_{const}, s₀, s₁, s₂, s₃)=(1, 1, 1, 1, 1), and is used for enabling the reconfigurable unit 1141 to calculate 2^{log}^{₂}^{(Psum}^{ᵢ}^{)-(m}^{ᵢ₊₁}^{-m}^{ᵢ}^{)·log}^{₂}^{e} through a corresponding data processing path. In a second stage 1502 of the Softmax function approximation method, one logical calculation procedure is included, which corresponds to a third setting of the control signal, for example, (s_{const}, s₀, s₁, s₂, s₃)=(1, 1, 1, 0, 1), and is used for enabling the reconfigurable unit 1141 to calculate 2^{(x}^{ⱼ}^{-max(x))·log}^{₂}^{e-log}^{₂}^{(OnNorm(x))} through a corresponding data processing path. According to the data processing procedure of the foregoing Softmax function approximation method, a j^{th} output component Sⱼ(x) of the Softmax function can be obtained.

FIG. 16 is a flowchart of a data processing procedure of a GELU function approximation method according to an embodiment of the present invention. In an embodiment shown in FIG. 16, the GELU function approximation method includes a first stage 1601 and a second stage 1602. In a first stage 1601 of the GELU function approximation method, one logical calculation procedure is included, which corresponds to a fourth setting of the control signal, for example, (s_{const}, s₀, s₁, s₂, s₃)=(2, 0, 0, 0, 0), and is used for enabling the reconfigurable unit 1141 to calculate e^{-αB(x)}=2^{B(x)·α·log}^{₂}^{e} through a corresponding data processing path. In the first stage 1601 of the GELU function approximation method, one logical calculation procedure is included, which corresponds to a fifth setting of the control signal, for example, (s_{const}, s₀, s₁, s₂, s₃)=(0, 0, 0, 0, 1), and is used for enabling the reconfigurable unit 1141 to calculate 2^{-log}^{₂}^{(1+e}^{^{−αB(x)}}) through a corresponding data processing path. Then, 2^{-log}^{₂}^{(1+e}^{^{−αB(x)}}) is multiplied by an input value x to obtain x·2^{-log}^{₂}^{(1+e}^{^{−αB(x)}}). The foregoing operation is used for enabling a function B(x) to more effectively approximate a curve shape of a standard normal distribution function Φ(x), where B(x) is a Sigmoid function, or a Sigmoid function optimized based on a scaling parameter α and a shift parameter β. According to the data processing procedure of the foregoing GELU function approximation method, an output G(x) of the GELU function can be obtained.

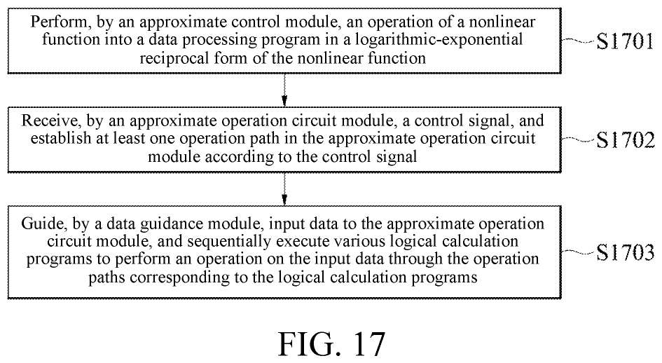

FIG. 17 is an approximate operation execution method for a nonlinear function processing apparatus according to an embodiment of the present invention. In an embodiment shown in FIG. 17, the approximate operation method for the nonlinear function processing apparatus includes: performing, by an approximate control module 120, an operation of a nonlinear function into a data processing procedure in a logarithmic-exponential reciprocal form of the nonlinear function (S1701), where the data processing procedure includes at least one logical calculation procedure, and each logical calculation procedure corresponds to a control signal; receiving, by approximate operation circuit modules (110, 1100), the control signal, and establishing at least one operation path in the approximate operation circuit modules (110, 1100) according to the control signal (S1702); and guiding, by a data guidance module 130, input data to the approximate operation circuit modules (110, 1100), and sequentially executing various logical calculation procedures to perform an operation on the input data through the operation paths corresponding to the logical calculation procedures (S1703).

In an embodiment, the approximate operation method for the nonlinear function processing apparatus further includes: dividing, by the data guidance module 130, the input data into a plurality of data subsets, and processing a plurality of data subsets in each data subset through the approximate operation circuit module 1100 in turns in batches; performing, by a comparison circuit module 1110 in the approximate operation circuit module 1100, a comparison operation on each data subset to obtain a maximum value of the plurality of data elements corresponding to each data subset; and performing, by an addition circuit module 1150 in the approximate operation circuit module 1100, an accumulation operation on a plurality of operation results output by a reconfigurable circuit module 1140 in the approximate operation circuit module 1100, to obtain a sum value of the plurality of data subsets, where operations are sequentially performed on various data subsets according to corresponding data processing procedures by repeatedly scheduling a shared circuit structure resource of the approximate operation circuit module 1100, and a recursive update operation is executed by a reconfigurable unit 1142 in the reconfigurable circuit module 1140 to dynamically update a maximum value and a sum value.

What is claimed is:

1. A nonlinear function processing apparatus, applied to a neural network system, comprising:
an approximate operation circuit module, disposed in a hardware structure and configured to selectively execute one of a plurality of functional operation modules according to a control signal to perform an approximate operation of a nonlinear function corresponding to the selected functional operation module;
an approximate control module, coupled to the approximate operation circuit module and configured to execute an operation of a data processing procedure in a logarithmic-exponential reciprocal form corresponding to the nonlinear function corresponding to the selected functional operation module, and analyze the data processing procedure to obtain the corresponding control signal, to dynamically establish at least one corresponding operation path in the approximate operation circuit module; and
a data guidance module, coupled to the approximate operation circuit module and configured to guide input data required by the data processing procedure to the approximate operation circuit module, and perform a corresponding operation on the input data according to the established at least one operation path.

2. The nonlinear function processing apparatus according to claim 1, wherein the plurality of functional operation modules comprise a Softmax operation module, a GELU operation module, and a square root operation module, and the Softmax operation module, the GELU operation module, and the square root operation module form a shared circuit structure of the approximate operation circuit module, wherein
the Softmax operation module is configured to execute an operation of the data processing procedure in the logarithmic-exponential reciprocal form corresponding to a Softmax function through the shared circuit structure;
the GELU operation module is configured to execute an operation of the data processing procedure in the logarithmic-exponential reciprocal form corresponding to a GELU function through the shared circuit structure; and
the square root operation module is configured to execute an operation of the data processing procedure in the logarithmic-exponential reciprocal form corresponding to a square root function through the shared circuit structure.

3. The nonlinear function processing apparatus according to claim 2, wherein the logarithmic-exponential reciprocal form of the nonlinear function is used for inferring a plurality of calculation formulas, the data processing procedure in the logarithmic-exponential reciprocal form comprises at least one logical calculation procedure, and each logical calculation procedure comprise one or more of the plurality of calculation formulas and respectively correspond to one or more of the at least one operation path of the approximate operation circuit module.

4. The nonlinear function processing apparatus according to claim 3, wherein the approximate control module is configured to establish at least one data reuse path after the logical calculation procedure is executed, and the data guidance module is configured to repeatedly guide an operation result of the approximate operation circuit module to the approximate operation circuit module through the data reuse path for a subsequent logical calculation procedure to use.

5. The nonlinear function processing apparatus according to claim 1, wherein the approximate operation circuit module comprises:
a selection circuit module, comprising a plurality of selector units;
a reconfigurable circuit module, comprising a plurality of reconfigurable units, and electrically connected to the selection circuit module;
an addition circuit module, comprising a plurality of adders, and electrically connected to the reconfigurable circuit module; and
a multiplication circuit module, comprising a plurality of multipliers, and electrically connected to the addition circuit module, wherein
the reconfigurable unit comprises:
a binary logarithmic operator, configured to execute an approximate operation of a corresponding binary logarithm through a binary logarithmic approximate formula; and
a binary exponential operator, configured to execute an approximate operation of a corresponding binary exponent through a binary exponential approximate formula.

6. The nonlinear function processing apparatus according to claim 5, wherein the approximate operation circuit module comprises:
a comparison circuit module, comprising a plurality of comparators, and configured to perform comparison operations on the input data through the plurality of comparators to obtain a maximum value of the input data;
a first register module, comprising a plurality of register units, and configured to store the input data and a comparison result of the comparison circuit module; and
a second register module, comprising a plurality of register units, and configured to respectively store operation results of the plurality of reconfigurable units, an accumulation result of the addition circuit module, and the comparison result of the comparison circuit module stored in the first register module.

7. The nonlinear function processing apparatus according to claim 2, wherein the GELU function is defined by an approximate formula:
$${G}_{σ} ( x ) = x \cdot σ ( α ( x + β ) ) = x \cdot \frac{1}{1 + {e}^{- a ( x + β )}}$$
wherein σ(x) represents a Sigmoid function, a represents a scaling parameter, β represents a shift parameter, and the scaling parameter and the shift parameter are obtained through a Quasi-Newton method.

8. An approximate operation circuit module for processing a nonlinear function operation, applied to a neural network system, comprising:
a selection circuit module, comprising a plurality of selector units;
a reconfigurable circuit module, comprising a plurality of reconfigurable units, and electrically connected to the selection circuit module;
an addition circuit module, comprising a plurality of adders, and electrically connected to the reconfigurable circuit module; and
a multiplication circuit module, comprising a plurality of multipliers, and electrically connected to the addition circuit module, wherein
the approximate operation circuit module is configured to selectively execute a data processing procedure in a logarithmic-exponential reciprocal form corresponding to a Softmax function, a GELU function, and a square root function through a shared circuit structure formed by the selection circuit module, the reconfigurable circuit module, the addition circuit module, and the multiplication circuit module, and dynamically establish, according to a control signal, at least one operation path corresponding to the data processing procedure in the logarithmic-exponential reciprocal form in the shared circuit structure, to implement a required operation.

9. The approximate operation circuit module for processing a nonlinear function operation according to claim 8, wherein the selector unit comprises:
a first selector, configured to input a positive value and a negative value of an operand β, and output a selection result of the first selector according to a most significant bit of input data; and
a second selector, configured to input the input data, the selection result of the first selector, and a value with a logical value of 0, and output a plurality of selection results of the second selector according to the control signal, wherein
a plurality of input ends of the selector unit are electrically connected to a plurality of input ends of the second selector, and a plurality of output ends of the selector unit are electrically connected to a plurality of output ends of the second selector.

10. The approximate operation circuit module for processing a nonlinear function operation according to claim 9, wherein the reconfigurable unit comprises:
a binary logarithmic operator, configured to input one of the plurality of selection results output by the selector unit, and execute an approximate operation of a corresponding binary logarithm through a binary logarithmic approximate formula to output an operation result of the binary logarithmic operator;
a third selector, configured to input the operation result of the binary logarithmic operator, and output a selection result of the third selector according to the control signal;
a first subtractor, configured to input the selection result of the third selector and another of the plurality of selection results output by the selector unit, and output an operation result of the first subtractor;
a first multiplier, configured to input the operation result of the first subtractor and a value of a multiplication operand corresponding to the control signal, and output an operation result of the first multiplier; and
a binary exponential operator, configured to input the operation result of the first multiplier, and execute an approximate operation of a corresponding binary exponent through a binary exponential approximate formula, to output an operation result of the binary exponential operator, wherein
a plurality of input ends of the reconfigurable unit are respectively electrically connected to the binary logarithmic operator and the first subtractor, and a plurality of output ends of the reconfigurable unit are respectively electrically connected to the first multiplier and the binary exponential operator.

11. The approximate operation circuit module for processing a nonlinear function operation according to claim 10, wherein the addition circuit module further comprises a plurality of addition enabling selectors that are respectively electrically connected to the plurality of adders; and the multiplication circuit module further comprises a plurality of multiplication enabling selectors that are respectively electrically connected to the plurality of multipliers, wherein the control signal comprises:
a selector control signal, configured to control the second selector in the selector unit;
a selection control signal and a multiplication control signal, configured to respectively control the third selector and the multiplier in the reconfigurable unit;
an adder control signal and an adder enabling signal, configured to respectively control the adder and the addition enabling selector in the addition circuit module; and
a multiplier control signal and a multiplier enabling signal, configured to control the adder and the multiplication enabling selector in the multiplication circuit module, wherein
when the multiplication control signal is 0, a value of the multiplication operand corresponding to the multiplication control signal is 1; when the multiplication control signal is 1, a value of the multiplication operand corresponding to the multiplication control signal is 0.5; when the multiplication control signal is 2, a value of the multiplication operand corresponding to the multiplication control signal is log₂ e; and when the multiplication control signal is 3, a value of the multiplication operand corresponding to the multiplication control signal is α·log₂ e.

12. The approximate operation circuit module for processing a nonlinear function operation according to claim 11, further comprising:
a register module, comprising a plurality of register units, the plurality of register units being disposed between the selector unit and the reconfigurable unit, between the reconfigurable unit and the adder, and between the adder and the multiplier; and
a clock gating controller module, comprising a plurality of clock gating controllers, the plurality of clock gating controllers being electrically connected to the plurality of register units, wherein
when a sleep signal is input into the clock gating controller, the clock gating controller pauses frequency output, to enable the plurality of register units to enter a low-power consumption state.

13. The approximate operation circuit module for processing a nonlinear function operation according to claim 8, further comprising:
a comparison circuit module, comprising a plurality of comparators, and configured to perform operations on input data through the plurality of comparators to obtain a maximum value of the input data;
a first register module, comprising a plurality of register units, and configured to store the input data and a comparison result of the comparison circuit module; and
a second register module, comprising a plurality of register units, and configured to respectively store operation results of the plurality of reconfigurable units, an accumulation result of the addition circuit module, and the comparison result of the comparison circuit module stored in the first register module.

14. The approximate operation circuit module for processing a nonlinear function operation according to claim 13, wherein the selector unit comprises:
a first selector, configured to input a positive value and a negative value of a operand β, and output a selection result of the first selector according to a most significant bit of the input data; and
a second selector, configured to input the input data, the selection result of the first selector, and a value with a logical value of 0, a value with a logical value of 1, and output a plurality of selection results of the second selector according to the control signal, wherein
a plurality of input ends of the selector unit are electrically connected to a plurality of input ends of the second selector, and a plurality of output ends of the selector unit are electrically connected to a plurality of output ends of the second selector.

15. The approximate operation circuit module for processing a nonlinear function operation according to claim 14, wherein the reconfigurable unit comprises:
a first subtractor, configured to input two of the plurality of selection results output by the selector unit, and output an operation result of the first subtractor;
a first multiplier, configured to input the operation result of the first subtractor and a value of a multiplication operand corresponding to the control signal, and output an operation result of the first multiplier;
a third selector, configured to input the operation result of the first multiplier and one of the plurality of selection results output by the selector unit, and output a selection result of the third selector according to the control signal;
a fourth selector, configured to input the operation result of the first multiplier and the value with the logical value of 0, and output a selection result of the fourth selector according to the control signal;
a binary logarithmic operator, configured to input the selection result of the third selector, and execute an approximate operation of a corresponding binary logarithm through a binary logarithmic approximate formula to output an operation result of the binary logarithmic operator;
a fifth selector, configured to input the operation result of the binary logarithmic operator and the selection result of the fourth selector, and output a selection result of the fifth selector according to the control signal;
a sixth selector, configured to input the selection result of the fourth selector and the operation result of the binary logarithmic operator, and output a selection result of the sixth selector according to the control signal;
a second subtractor, configured to input the selection result of the fifth selector and the selection result of the sixth selector, and output an operation result of the second subtractor;
a seventh selector, configured to input the operation result of the first multiplier and the operation result of the second subtractor, and output a selection result of the seventh selector according to the control signal; and
a binary exponential operator, configured to input the selection result of the seventh selector, and execute an approximate operation of a corresponding binary exponent through a binary exponential approximate formula to output an operation result of the binary exponential operator, wherein
a plurality of input ends of the reconfigurable unit are respectively electrically connected to the first subtractor and the third selector, and an output end of the reconfigurable unit is electrically connected to the binary exponential operator.

16. The approximate operation circuit module for processing a nonlinear function operation according to claim 15, wherein the control signal comprises:
a multiplication control signal, configured to control the multiplier in the reconfigurable unit to select the value of the corresponding multiplication operand;
a first selection control signal, configured to control the selection result of the third selector in the reconfigurable unit according to a value of the first selection control signal being 0 or 1;
a second selection control signal, configured to control the selection result of the fourth selector in the reconfigurable unit according to a value of the second selection control signal being 0 or 1;
a third selection control signal, configured to control the selection results of the fifth selector and the sixth selector in the reconfigurable unit according to a value of the third selection control signal being 0 or 1; and
a fourth selection control signal, configured to control the selection result of the seventh selector in the reconfigurable unit according to a value of the fourth selection control signal being 0 or 1, wherein
when the multiplication control signal is 0, a value of the multiplication operand corresponding to the multiplication control signal is 1; when the multiplier control signal is 1, a value of the multiplication operand corresponding to the multiplication control signal is log₂ e; and when the multiplication control signal is 2, a value of the multiplication operand corresponding to the multiplication control signal is a·log₂ e.

17. An approximate operation execution method for a nonlinear function processing apparatus, comprising:
transforming, by an approximate control module, an operation of a nonlinear function into a data processing procedure in a logarithmic-exponential reciprocal form corresponding to the nonlinear function, wherein the data processing procedure in the logarithmic-exponential reciprocal form comprises at least one logical calculation procedure, and each logical calculation procedure corresponds to a control signal;
receiving, by an approximate operation circuit module, the control signal, and dynamically establishing at least one corresponding operation path in the approximate operation circuit module according to the control signal; and
guiding, by a data guidance module, input data to the approximate operation circuit module, and sequentially executing various logical calculation procedures to perform approximate operations on the input data through the operation paths corresponding to the logical calculation procedures.

18. The approximate operation execution method for a nonlinear function processing apparatus according to claim 17, wherein the approximate operation circuit module comprises:
a binary logarithmic operator, configured to execute an approximate operation of a corresponding binary logarithm through a binary logarithmic approximate formula; and
a binary exponential operator, configured to execute an approximate operation of a corresponding binary exponent through a binary exponential approximate formula, wherein
the binary logarithmic approximate formula is:
$${log}_{2} x = {2}^{ω} \cdot k = ω + {log}_{2} k \approx ω + ( k - 1 )$$
wherein ω is an integer part of └log₂ x┘ and is capable of being obtained through a most significant bit of an input value x, and k is a proportional part corresponding to the input value x normalized to an interval [1,2); and
the binary exponential approximate formula is:
$${2}^{x} = {2}^{{x}_{i n t} + {x}_{f r a c}} \approx ( 1 + {x}_{f r a c} ) \cdot {2}^{{x}_{i n t}}$$
wherein xᵢₙₜ is an integer part of the input value x, and x_{frac} is a decimal part obtained by deducting the integer part from the input value x.

19. The approximate operation execution method for a nonlinear function processing apparatus according to claim 17, further comprising:
dividing, by the data guidance module, the input data into a plurality of data subsets, and processing a plurality of data elements in each data subset in turn in batches through the approximate operation circuit module;
performing, by a comparison circuit module in the approximate operation circuit module, a comparison operation on each data subset to obtain a maximum value of the corresponding plurality of data elements in each data subset; and
performing, by an addition circuit module in the approximate operation circuit module, an accumulation operation on a plurality of operation results output by a reconfigurable circuit module in the approximate operation circuit module, to obtain a sum value of the plurality of data subsets, wherein
the approximate operation circuit module is repeatedly executed for a plurality of times, and one of a plurality of reconfigurable units in the reconfigurable circuit module executes a recursive update operation to dynamically update the maximum value and the sum value.

20. The approximate operation execution method for a nonlinear function processing apparatus according to claim 17, wherein the approximate operation circuit module is a shared circuit structure formed by a Softmax operation module and a GELU operation module, wherein
the Softmax operation module executes an operation of the data processing procedure in the logarithmic-exponential reciprocal form corresponding to a Softmax function through the shared circuit structure; and
the GELU operation module executes an operation of the data processing procedure in the logarithmic-exponential reciprocal form corresponding to a GELU function through the shared circuit structure, wherein
the logarithmic-exponential reciprocal form of the Softmax function is expressed as:
$${S}_{j} ( x ) = \frac{{e}^{{x}_{j} - M}}{{\sum }_{i = 0}^{N - 1} {{e}^{{x}_{i}}}^{- M}} = {2}^{l o {g}_{2} e ( {x}_{j} - M ) - lo {g}_{2} ( {\sum }_{i = 0}^{N - 1} {e}^{{x}_{i} - M} )} s$$
expressed as a maximum value of the input data; and
the logarithmic-exponential reciprocal form of the GELU operation module is expressed as:
$${G}_{σ} ( x ) = x \cdot σ ( 1.702 x ) = x \cdot {2}^{- l o {g}_{2} ( 1 + {e}^{- 1.702 x} )}$$
in σ(x) is a Sigmoid function.
